(19) United States
(12) Patent Application Publication
(10) Pub. No.: US 2020/0134150 A1
(43) Pub. Date: Apr. 30, 2020

(54) FACILITATING RETRIEVAL OF PERMISSIONS ASSOCIATED WITH A MEDIA ITEM

(71) Applicant: BYLINED ME, INC., COLUMBUS, OH (US)

(72) Inventor: DAVID BERHANE HUNEGNAW, COLUMBUS, OH (US)

(21) Appl. No.: 16/688,682

(22) Filed: Nov. 19, 2019

Related U.S. Application Data
(63) Continuation of application No. 15/642,775, filed on Jul. 6, 2017, now abandoned.

(51) Int. Cl. G06F 21/32; G06Q 50/18; G06K 9/00; G06N 20/00; G06F 21/64; G06F 21/10

(52) U.S. Cl. CPC G06F 21/32; G06Q 50/184; G06K 9/00228; G06Q 50/01; G06N 20/00; G06F 21/64; G06F 21/10; G06K 9/00288

(57) ABSTRACT

The subject disclosure relates to employing identification, tagging, and intake components to facilitate a retrieval of permissions associated with use of media content items. In an example, a method comprises identifying, by a system operatively coupled to a processor, facial data within a media content item based on a facial recognition algorithm. In another aspect, the method comprises tagging, by the system, identified facial data within the media content item with identification data. Furthermore, in an aspect, the method comprises receiving, by the system, signature data that corresponds with first document data representing a permissive use of the identification data and the identified facial data for a defined purpose.

### CROSS-REFERENCE TO RELATED APPLICATIONS

This application claims priority to U.S. patent application Ser. No. 15/642,775 titled, “FACILITATING RETRIEVAL OF PERMISSIONS ASSOCIATED WITH A MEDIA ITEM”, filed on Jul. 6, 2017. The entirety of the disclosures of the aforementioned applications are considered part of, and is incorporated by reference, in the disclosure of this application.

### BACKGROUND

The recent rise of user generated content, or content created by users and published via conventional and unconventional means, has brought about a host of problems and issues related to the use of such content. In some instances, user generated content can be used for advertising purposes, such as a user generated photograph depicting a user using a product. While there are a variety of sources of such user generated content, the act of obtaining appropriate permission to use content such as photographs, videos, or voice recordings that contain the likeness of relevant users has been a problem for several organizations and users. Typically, a user can respond to a media item presented at on a social platform with a hashtag response (e.g., #iapprove) arguably granting a loose set of permissions to use a media item, associated with the message response, including the user or user's likeness (e.g., face, identity, name, etc.) for a commercial or social purpose.

However, this process of obtaining permissions, releases, and rights to use a media item from various users is flawed in several ways. For instance, a user submitting the response via social media may not be the individual submitting the media item to social media or may not be the creator of the media item and in some instances may not have the standing or authority to grant usage rights to a brand. Accordingly, advertisers, marketers, and any organization or individual distributing media items containing the likeness of users and whom attempt to obtain permissions in this manner, take significant risk in reusing or highlighting earned user generated content. Also, simply tweeting a hashtag followed by a word or phrase does not detail the activities, rights, or media items by which a grant of permission is provided. Furthermore, such risks are associated with expensive and significant consequences to the violating party. Accordingly, technologies, techniques, and mechanisms for obtaining permission to utilize user generated content or other digital content from relevant parties are needed.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ system components facilitate a receipt of authentication data in connection with permission data representing a permissive use of a media content item.

According to an embodiment, a system is provided. The system comprises a processor that executes computer executable components stored in memory. The computer executable components comprise an identification component that identifies facial data within a media content item based on a facial recognition algorithm. Further, the computer executable components comprise a tagging component that assigns tag data to the identified facial data within the media content item. In another aspect, the computer executable component can comprise an intake component that receives authentication data based at least in part on the tag data, wherein the authentication data is coupled with permission data representing a grant of permissive use of the identified facial data coupled to tag data.

According to another embodiment a computer-implemented method is provided. The computer-implemented method can comprise identifying, by a system operatively coupled to a processor, facial data within a media content item based on a facial recognition algorithm. The computer-implemented method can also comprise tagging, by the system, identified facial data within the media content item with identification data. In an aspect, the computer-implemented method can also comprise receiving, by the system, signature data that corresponds with first document data representing a permissive use of the identification data and the identified facial data for a defined purpose.

According to yet another embodiment, a computer program product for facilitating a receipt of signature data in connection with document data representing an execution of an agreement for permissive use of a media content item is provided. The computer program product can comprise a computer readable storage medium having program instructions embodied therewith, the program instructions executable by a processor to cause the processor to identify facial data within a media content item based on a facial recognition algorithm. The computer program product can also cause the processor to tag identified facial data within the media content item with identification data. In another aspect, the computer program product can cause the processor to receive signature data that corresponds with first document data representing a permissive use of the identification data and the identified facial data for a defined purpose.

### BRIEF DESCRIPTION OF THE DRAWINGS

FIG. 1A illustrates a block diagram of an example, non-limiting system 100 that can facilitate a retrieval of permissions associated with usage of media content items in accordance with one or more embodiments described herein.

FIG. 1B illustrates a diagram of an example, non-limiting device rendering a captured image for facial recognition analysis in accordance with one or more embodiments described herein.

FIG. 1C illustrates a diagram of an example, non-limiting device rendering an identified face within a captured image in accordance with one or more embodiments described herein.

FIG. 1D illustrates a diagram of an example, non-limiting device rendering a tagged and identified face within a captured image in accordance with one or more embodiments described herein.

FIG. 1E illustrates a diagram of an example, non-limiting device rendering document data for execution in association with the captured image in accordance with one or more embodiments described herein.

FIG. 1F illustrates a diagram of an example, non-limiting device rendering a captured logo image in accordance with one or more embodiments described herein.

FIG. 1G illustrates a diagram of an example, non-limiting device rendering document data for execution in association with the captured logo in accordance with one or more embodiments described herein.

FIG. 2 illustrates a block diagram of an example, non-limiting system 200 that can determine whether identified facial data is partial facial data or complete facial data and retrieve permissions associated with usage of media content items including facial data or incomplete facial data in accordance with one or more embodiments described herein.

FIG. 3 illustrates a block diagram of an example, non-limiting system 300 that can generate document data and retrieve permissions associated with usage of media content items in accordance with one or more embodiments described herein.

FIG. 4 illustrates a block diagram of an example, non-limiting system 400 that can execute a machine learning model based on identified facial data input and retrieve permissions associated with usage of media content items in accordance with one or more embodiments described herein.

FIG. 5 illustrates a block diagram of an example, non-limiting system 500 that can generate prediction data comprising predictive facial data and predictive identification data associated with another media content item and retrieve permissions associated with usage of media content items in accordance with one or more embodiments described herein.

FIG. 6 illustrates a block diagram of an example, non-limiting system 600 that can modify facial recognition data, identification data, and signature data into combinatorial data and retrieve permissions associated with usage of media content items in accordance with one or more embodiments described herein.

FIG. 7 illustrates a block diagram of an example, non-limiting system 700 that can retrieve a media content item from a data store and retrieve permissions associated with usage of media content items in accordance with one or more embodiments described herein.

FIG. 8 illustrates a block diagram of an example, non-limiting system 800 that can rank the partial facial data and the complete facial data based on a set of relevancy scores and retrieve permissions associated with usage of media content items in accordance with one or more embodiments described herein.

FIG. 9 illustrates a block diagram of an example, non-limiting system 900 that can facilitate a generation of an assignment profile comprising a media content item sourcing framework and retrieve permissions associated with usage of media content items sourced within the media content item sourcing framework in accordance with one or more embodiments described herein.

FIG. 10 illustrates a block diagram of an example, non-limiting system 1000 that can retrieve permissions associated with usage of media content items sourced within the media content item sourcing framework over a cloud computing network in accordance with one or more embodiments described herein.

FIG. 11 illustrates a flow diagram of an example, non-limiting computer-implemented method 1100 that can facilitate a retrieval of permissions associated with usage of media content items in accordance with one or more embodiments described herein.

FIG. 12 illustrates a flow diagram of an example, non-limiting computer-implemented method 1200 that can facilitate a retrieval of permissions associated with usage of media content items and determine whether identified facial data is partial facial data or complete facial data in accordance with one or more embodiments described herein.

FIG. 13 illustrates a flow diagram of an example, non-limiting computer-implemented method 1300 that can facilitate a generation of customized waiver data corresponding to usage of media content items in accordance with one or more embodiments described herein.

FIG. 14 illustrates a flow diagram of an example, non-limiting computer-implemented method 1400 that can group input media content items with defined tag data in accordance with one or more embodiments described herein.

FIG. 15 illustrates a flow diagram of an example, non-limiting computer-implemented method 1500 that can rank the partial facial data and the complete facial data based on a set of relevancy scores in accordance with one or more embodiments described herein.

FIG. 16 illustrates a block diagram of an example, non-limiting operating environment 1600 in which one or more embodiments described herein can be facilitated.

FIG. 17 illustrates a block diagram of an example, non-limiting operating environment 1700 in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed herein is a technology that allows users to obtain permissions to make, use, sell, license and perform a range of activities associated with user-generated content the contains information (e.g., images, audio, video) of other users or such other users “likeness”. In an aspect, users can utilize a platform described herein to generate and submit user generated content to organizations or brands for use in commercial purposes such as advertisements or marketing purposes. However, there is currently no mechanism in place to allow for users whom generate such content (e.g., images, video, audio) to obtain permissions from the models within the generated content.

The systems, methods and devices disclosed herein allow users to obtain permission from all or those relevant models captured in the generated media content within seconds or minutes after the content is generated. As such, the users whom generate user generated content can properly monetize or convey the generated content to third parties for use without having to undertake liability or worry about not having the proper permissions to use and/or sell the generated media content item. Furthermore, in an aspect, the organization, individual, or brand seeking to utilize the media content item for commercial purposes (e.g., to facilitate an advertising or marketing of a product or good) can purchase the user generated content from the user whom generated the content and satisfy due diligence requirements (e.g., business, legal, etc.). Furthermore, the permissions can be granted by an authorized user and captured as permission data and authentication data such that the purchaser can easily integrate such data with its own systems and/or platforms. The ability to generate media content items, receive and generate permission data (e.g., from relevant parties), receive and generate authentication data from authorized entities (e.g., the models), combine data sets (e.g., permission data, authentication data, media content data, identity data, etc.) and store such data for efficient access and use are all disclosed herein.

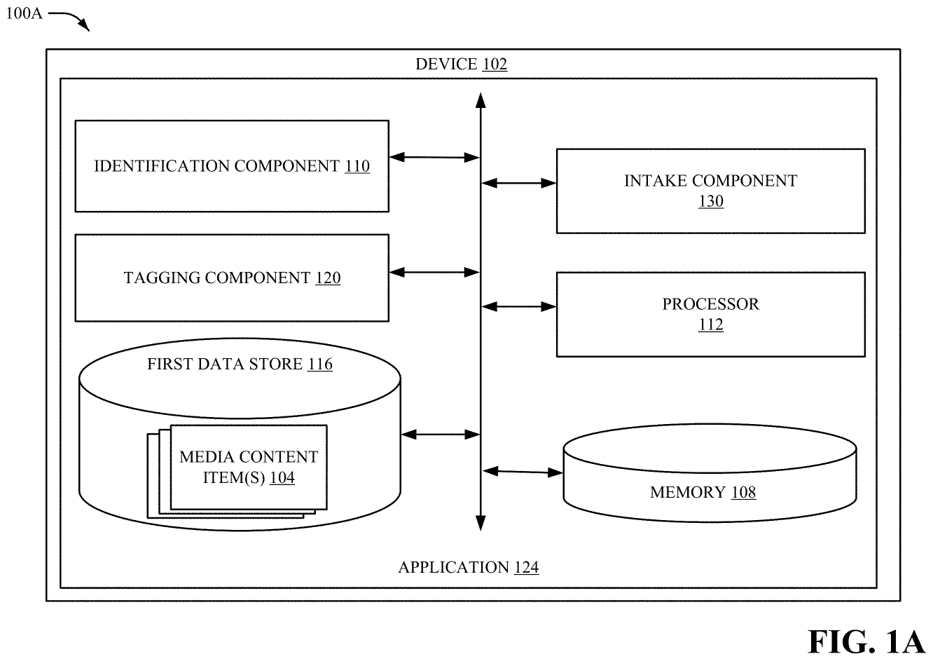

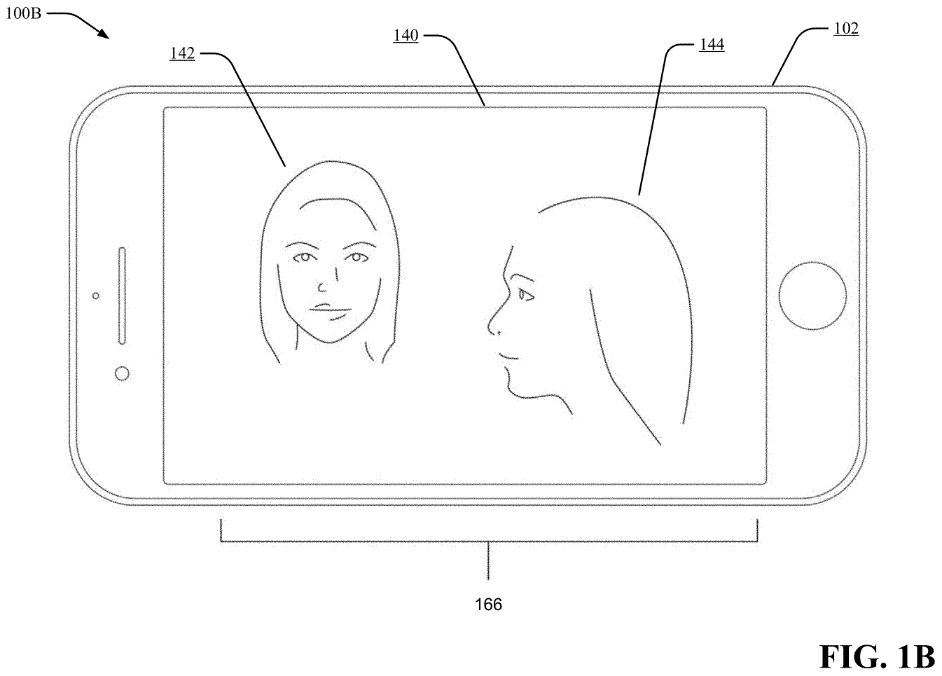

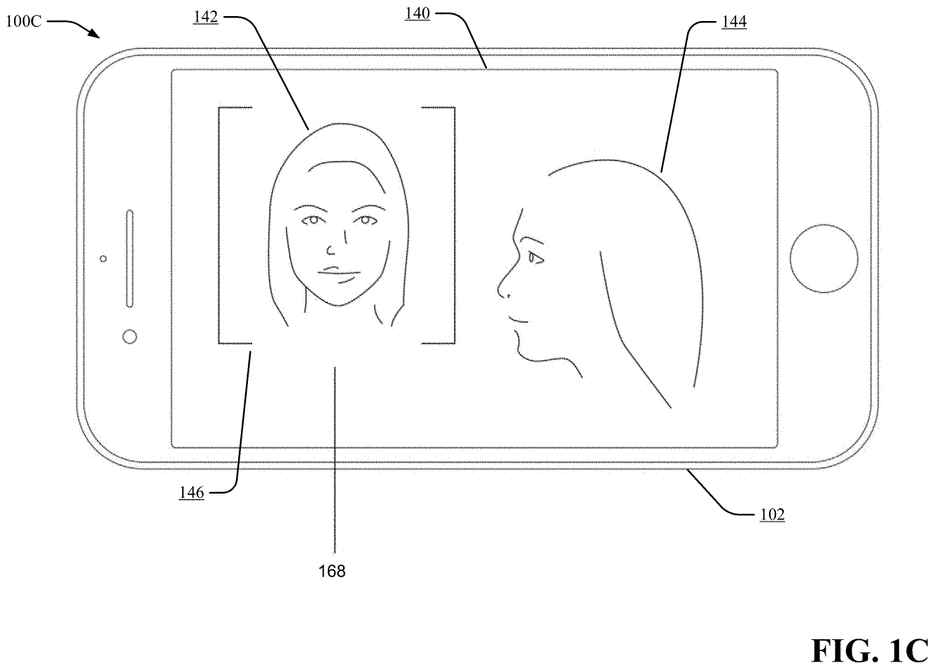

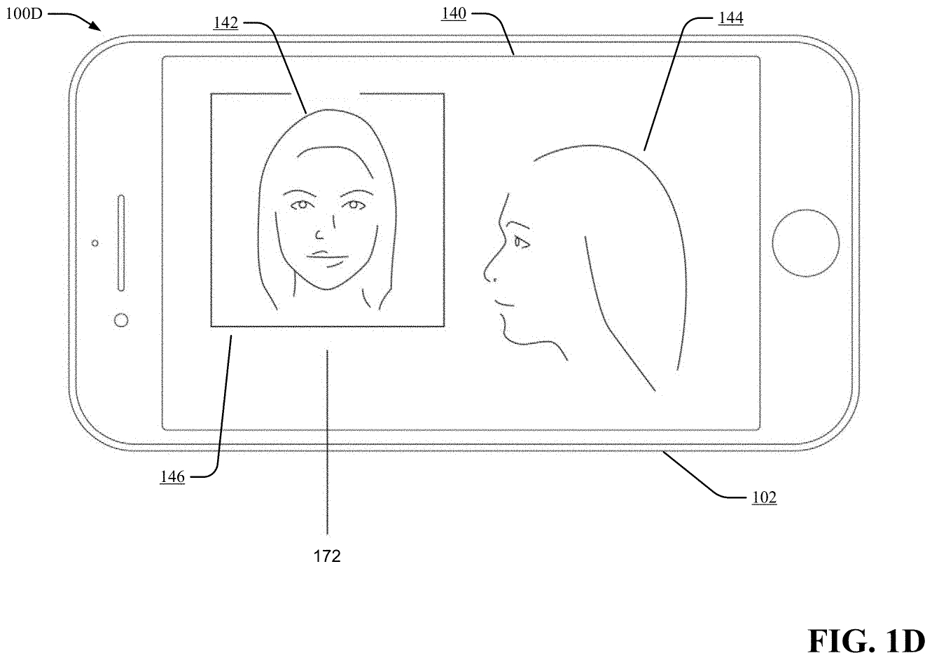

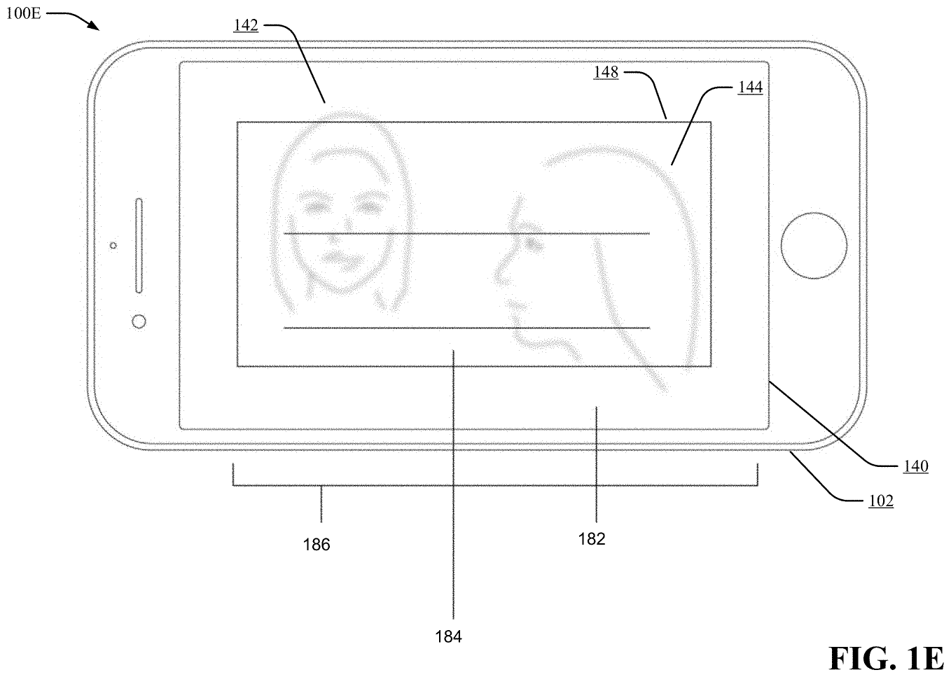

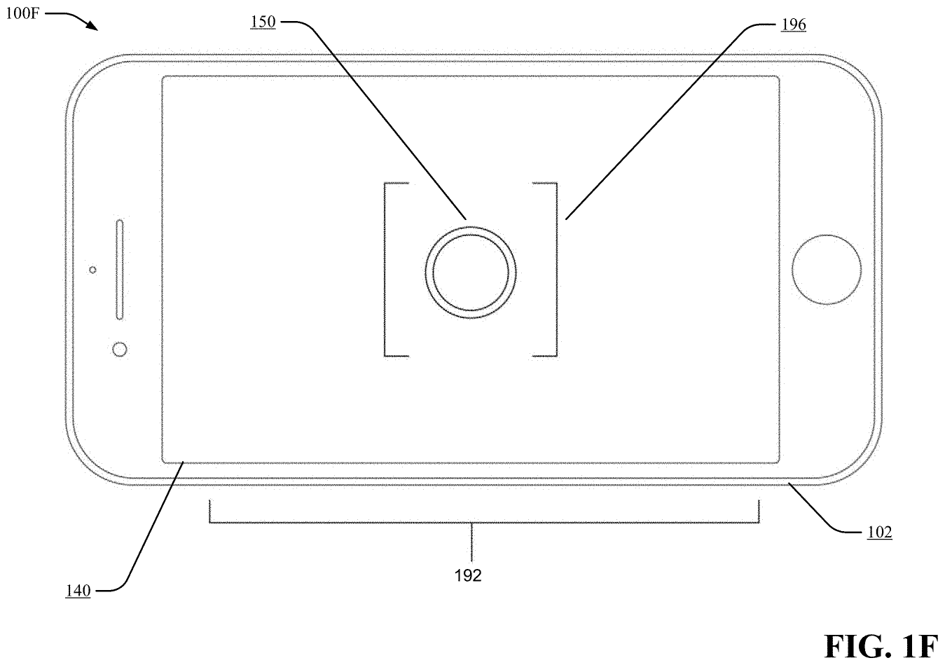

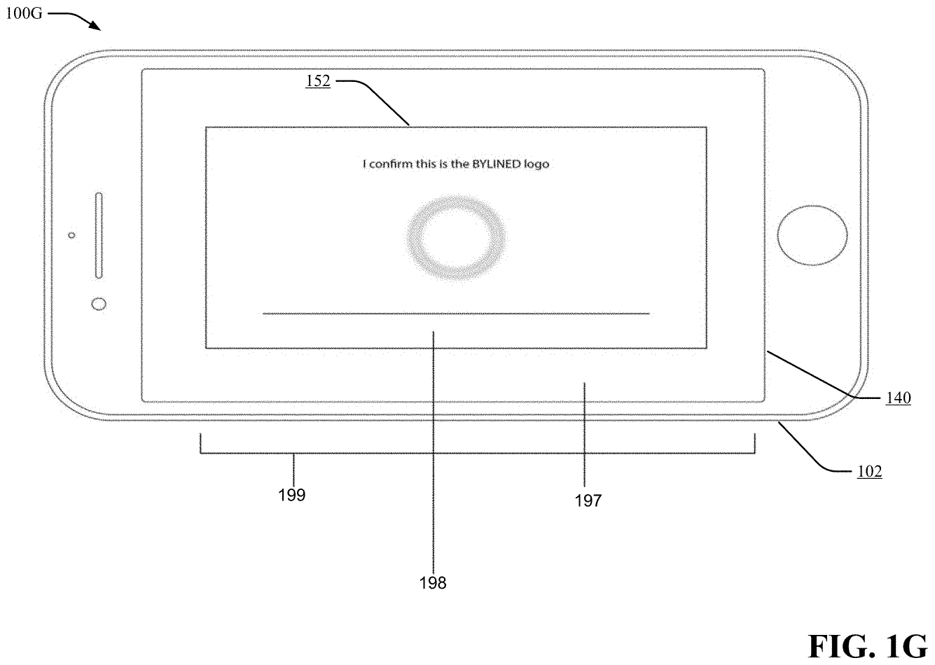

FIG. 1A illustrates a block diagram of an example, non-limiting system 100A that can facilitate a retrieval of permissions associated with usage of media content items in accordance with one or more embodiments described herein. In an aspect, system 100A can comprise

In an aspect, system 100A can operate on one or more devices including device 102 (e.g., a smart phone). In an aspect, system 100A can comprise or otherwise access (via a network) first data store 116 that stores media content item(s) 104. In an aspect, system 100A can comprise processor 112 and memory 108. In an aspect, processor 112 can execute the computer executable components and/or computer instructions stored in memory 108. The components of system 100A can include identification component 110, tagging component 120, and intake component 130. In an aspect, one or more of the components of system 100A can be electrically and/or communicatively coupled to one or more devices of system 100A or other system embodiments to perform one or more functions described herein.

In an aspect system 100A can comprise a memory 108 that stores computer executable components and a processor 112 that executes the computer executable components stored in the memory 108. In an aspect, memory 108 can store identification component 110, tagging component 120, and intake component 130. Furthermore, system 100A can employ application 124, which in an embodiment, can be a software application capable of initiation on a device (e.g., user device such as a mobile phone, tablet, computer, etc.). In an aspect, the initiation of the application 124 can include the starting, initiating, launching, or running or triggering of the application 124 and one or more system 100A components executed by the processor 112 and associated with the application 124. In another aspect, system 100A can comprise a first data store 116 where media content item(s) 104 can be stored. Furthermore, the various embodiments described herein can be implemented in connection with any computer or server device, which can be deployed as part of a computer network or in a distributed computing environment. This includes, but is not limited to, an environment with server computers and client computers deployed in a network environment or a distributed computing environment, having remote or local storage.

In an aspect, a distributed computing environment can provide sharing of computer resources and services by a communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and other such purposes. In an aspect, distributed computing can take advantage of network connectivity, allowing clients to leverage their collective power to benefit the entire enterprise. As such, a variety of devices may have applications, objects or resources that may participate in the mechanisms as described for various embodiments of this disclosure. In another aspect, the techniques described herein can be applied to any device suitable for implementing various embodiments described herein. Handheld, portable and other computing devices and computing objects of all kinds are contemplated for use in connection with the various embodiments (e.g., devices that can read or write transactions from or to a data store).

In an aspect, system 100A can employ processor 112 to execute (e.g., execute instructions, commands, operations or tasks) identification component 110 that identifies (e.g., causes a device executing system 100A components to execute identification operations) facial data within a media content item 104 based on a facial recognition algorithm. In an aspect, system 100A can utilize media content items 104 such as a video file (e.g., comprising video data), audio file (comprising audio data), an image file (e.g., comprising image data) and other such media content items stored at a first data store 116, which can be located on a device 102 such as a smart phone device, server device, media content server, computer, tablet, personal digital assistant, set-top box, or any other such device. The media content item 104 can be user generated such as a video file, image file, or audio file captured by a user on a user device 102. In another aspect, the media content item 104 can be sourced from media content databases (e.g., platforms that intake video files, etc.). In another aspect, the video files can include a video file, a video clip, a video segment, a video sample, or other such video types. Furthermore, in an aspect, an image file can include pixel data, lamination data, a range of image file formats (e.g., codec compression format, etc.), and other such image types. In another aspect, the audio file can include an audio file, an audio clip, an audio sample, a music file, a music clip, a music sample, a song, a sound, a dialogue, or other such audio type.

In an aspect, identification component 110 can identify facial data within media content item 104. For example, in an instance, media content item 104 can be a digital picture capturing several people eating a snack, smiling, and interacting with one another. As such, identification component 110 can identify the data that pertains to the people's faces. The identification of facial data can include framing the facial data by presenting a box (e.g., square or rectangle) around a depicted face such that a user interface of the device 102 presenting the image can also present frames around faces (e.g., facial data) within the image. In an aspect, identification component 110 can identify the facial data based on a facial recognition algorithm. For example, identification component 110 can employ any one or more of a range of facial recognition algorithms or techniques such as principal component analysis, independent component analysis, linear discriminant analysis, Eigenspace-based adaptive approach, elastic bunch graph matching (EBGM), kernel methods, trace transform methods, surface texture analysis, active appearance model, 3D morphable model, 3D face recognition, Bayesian framework, support vector machine techniques, hidden Markov models, boosting & ensemble solutions, and other such facial recognition algorithms.

In another aspect, identification component 110 can utilize a range of facial characteristic data to identify the facial data within a media content item 104. For instance, facial data can represent lighting characteristics associated with a face, age-indicating features on a face, facial expressions, facial recognition landmarks, various facial viewpoint configurations, psychology attributes, face wearable's (e.g., glasses, ear rings, nose rings, braces, etc.), and other facial data characteristics. In yet another aspect, identification component 110 can identify brand data and/or object data within a media content item 104 as well. For instance, a media content item 104 can be a digital image (e.g., including image data) that captures a product such as a soda can with a brand logo on the can. In an aspect, identification component 110 can identify the object data representing the soda can and the brand data (subset of image data) representing the logo and alphanumeric symbol located on the can.

Accordingly, processor 112 can execute identification component 110 to identify important aspects within a media content item 104 such as data representing goods, services, people, faces, and other characteristics of the media content item 104. Furthermore, in an aspect, identification component 110 can utilize algorithms that measure unique characteristics within the media content item 104, quantify such characteristics, and match them against data representations of similar characteristics stored in one or more database to facilitate the performance of identification tasks. In an aspect, identification component 110 can identify facial data, object data, and/or brand data within a media content item 104 in order to identify commercially valuable elements of such media content item 104. For instance, media content item 104 can identify facial data of people consuming a product in a captured digital image rather than the people incidentally captured in the background of the digital image that have no significant nexus to the commercial use of the good being highlighted in the digital image.

Furthermore, in an aspect, identification component 110 can identify facial data and other data sets within a media content item 104 for purposes of authentication. For instance, identification component 110 can capture brand data associated with several diverse types of logos within a digital image or in one type of logo within a digital image. If the objective of the identification task (e.g., performed using identification component 110) is to identify media content items that include a type of logo belonging to a respective organization, then identification component 110 can identify such particular sought after logo data. In an instance, identification component 110 can identify logo data in order to facilitate a determination of the relevance of the media content item 104.

As such, if identified brand data or object data within a media content item 104 represents a logo of a particular brand or a good belonging to a particular organization respectively, then such media content item 104 can be paired, transmitted or coupled to a marketing campaign of an organization whom may be interested in the media content item 104 (e.g., purchasing and/or using the media content item 104). In another aspect, identification component 110 can identify relevant facial data, object data, brand data (e.g., logo, symbol, color scheme, etc.) by generating box data representing a frame displayed around the relevant identified data (e.g., facial data, object data, brand data) subset within the media content item 104. As such, a user generating the media content item 104 can utilize such identification information (e.g., frame data) to adjust the media content item 104 to highlight such commercially valuable attributes of the content item or to determine a target organization or entity, to whom, the user can transmit such media content item 104. For instance, the application 124 can identify via a frame, an identified person or product within a digital image, and accordingly, the user whom generated such image can submit the image to a target organization based on the identified person or product.

In another aspect, system 100A can also employ processor 112 to execute (e.g., execute instructions, commands, operations or tasks) tagging component 120 that assigns tag data to the identified facial data within the media content item 104. In an aspect, tagging component 120 can assign tag data to identified facial data, object data, brand data and other such identified data to allow for an efficient and effective search mechanism for finding relevant and useful attributes within a media content item 104. For instance, processor 112 can execute a search task to identify (e.g., using identification component 110) facial data within media content item 104 associated with a particular person that represents an ideal promotional figure of a brand. As an example, a person or user captured in a media content item 104 that consistently smiles thus exposing the whiteness of numerous teeth may indicate that such media content item 104 is of high relevancy for marketing teeth whitener products. As such, a search for tag data (e.g., assigned to identified facial data using tagging component 120 in connection with identification component 110) associated with the facial data of the person can identify (e.g., using identification component 110) the relevant media content items 104 capturing such relevant facial data. For instance, the tag data can be a keyword (e.g., white teeth, models name, target brand for acquisition) associated with the facial data, a classification tag (e.g., hashtag), location based tag, a knowledge tag and any one or more of a variety of other such tags.

In another aspect, tagging component 120 in connection with intake component 130 can facilitate an intake of tag data (e.g., receiving input tag data from a user) for assignment to a data subset within media content item 104, provide suggestions of tag data (e.g., to facilitate an array of selectable tag data capable of becoming data input) to a user at a user interface of device 102, and/or automatically populate tag data to correspond with a respective data subset (e.g., facial data, object data, brand data, etc.). In an aspect, the tag data can be assigned (e.g., using tagging component 120) to the respective data subset by a mapping, coupling, pairing, integration or merging mechanism. For instance, data associated with the media content item 104 can be stored within and accessed from first data store 116. Also, identification data (e.g., generated using identification component 110) can be stored within and/or accessed from first data store 116 or another data store other than first data store 116. In yet another aspect, tag data (e.g., generated using tagging component 120) can be stored within and/or accessed from first data store 116 or another data store other than first data store 116. As such, the tag data, identification data, and/or other data associated with media content item 104 can reside at different data repositories and be combined (e.g., merging data stores containing the data items or transplanting data points for combination at a new data store).

In an aspect, the identification data, media content item 104 data, and tag data can include structured or unstructured metadata. All or a portion of the different data types can be integrated into a schema that represents the various attributes represented by each respective data set. Furthermore, in an aspect, the integrated data can be converted into standardized data representing standardized relationships or attributes of the combinatorial data such that they can be efficiently organized, sorted, searched and/or identified. In another aspect, the merging of data types including identification data, media content item data 104 and tag data can occur by transitioning and integrating unstructured data into structured data. In an aspect, such integration or merging of data subsets and types can be utilized in processing operations associated with system 100A that require less time and computational resources for execution. Furthermore, in an aspect, combinatorial data can be utilized by the system to facilitate execution of more efficient algorithms that can perform algorithmic operations (e.g., algorithms related to identification of data within media content items, assigning tags to identification data within a media content item, accessing data associated with a media content item, generating permission data associated with a media content item, etc.) efficiently, consume resources efficiently (e.g., lower computational cost), minimum memory usage (e.g., for data storage), and/or high processing speeds of system 100A components.

In another aspect, tagging component 120 can assign tags to various segments of a media content item 104. For instance, one or more portions of an image corresponding to facial data can be assigned tag data describing the respective facial data. For instance, tag data assigned to facial data can include a keyword or term assigned to a piece of information (e.g., digital image, one or more video frame, data record stored in a data repository). In an aspect, tag data associated with facial data can represent or include a person's name (e.g., of a person), a unique identifier (e.g., token data), associated with the facial data, a matching constrain identifier (e.g., a picture capturing a side profile of a face or front profile of a face), a descriptive attribute (e.g., child's face versus adults face), a measurement based tag (e.g., a proximity of a facial feature to a landmark feature such as a nose), quality indicators (e.g., high quality lighting associated with the facial data) and other such data representations.

In another aspect, the tag data can include metadata that represent facial recognition identifiers such as mechanisms to quantify attributes of a face such as histogram information, geometric elements to the face region, partitioning of facial regions, spatial appearance metrics, kernel-based classification descriptors, and other such statistical-based metrics. Furthermore, tag data can include a metadata tag (e.g., hashtag), a tag comprising meta-information (e.g., knowledge tag), or other such tag identifier or tag descriptor. In an aspect, tagging component 120 in connection with intake component 130 can present (e.g., at a user interface of device 102) a text box to receive input tag data. In an aspect, the input text can be converted into tag data and assigned to facial data, object data, brand data, and other such data types. In another aspect, the text box can allow input text data to be tokenized or to be composed of a range of syntax's.

In an aspect, the tag data can also represent a range of attributes to properly describe or characterize the object being tagged within the media content item 104. For instance, tag data can represent attributes that are relevant to commercially valuable elements of an image. As such tag data can represent commercially valuable attributes of a media content item 104 such as an image including the styling (e.g., wardrobe, makeup, props, food type, version of a product presented, etc.) of products or people within the image, a location in which the image was captured, the lighting associated with the image (e.g., properly exposed image versus over or under exposed image), framing elements (e.g., angles, cropping, and other shooting aspects), relevancy to a branding strategy (e.g., image consistent with a brand storyline). Accordingly, tagging component 120 can facilitate the assignment of tag data to an identified facial data, brand data (e.g., logo) and/or object data (e.g., associated with products, goods, or services) present within a media content item 104.

In another aspect, system 100A can employ processor 112 to execute an intake component 130 to receive authentication data based at least in part on the tag data, wherein the authentication data is coupled with permission data representing a grant of permissive use of the identified facial data coupled to tag data. As such, system 100A can employ intake component 130 to utilize generated permission data that can be presented at a user device interface (e.g., screen of a smart phone) and capable of receiving authentication data from relevant people (e.g., model) to use (e.g., sell, distribute, post, etc.) media content items 104 that include such relevant people within the media content item 104 data. In an aspect, intake component 130 can receive such authentication data based on tag data. In an instance, the tag data assigned (e.g., using tagging component 120) to facial data can identify the model associated with the identified (e.g., using identification component 110) facial data whom is authorized to grant permissions for using such model likeness or image with the media content item 104 for commercial purposes.

As such, the relevant user captured within the media content item 104 can input authentication data into a user device 102 at a user interface for receipt by intake component 130 of system 100A. For instance, processor 112 can execute intake component 130 to perform operations associated with receiving authentication data from a user and/or transmitting such received data to a data store (e.g., first data store 116). As an example, intake component 130 can provide instructions to the processor 112 to present a signature field at a user interface of a user device 102, wherein the device interface is configured to receive (e.g., using intake component 130) a user signature authorizing the use of the media content item 104 including the signing user's (e.g., model) facial data. In an aspect, intake component 130 can receive the signature data corresponding to the signature input at the user interface.

In an aspect, authentication data can represent information that confirms the identity of a person or thing. In an instance, authentication data can represent a range of items that convey an authority from an authenticated user to permit another entity (e.g., user or organization) to use a media content item 104. An authorized user can be a person (e.g., model) whom is captured within a media content item 104, such as a person presented in a photograph, in a video segment, a persons voice on an audio clip, and other such media content items 104. In an aspect, an authorized user can convey authentication data that represents a user signature (e.g., referred to as signature data), identification documentation (e.g., drivers license data, passport data, social security number data, etc.), a user biological identifier such as a fingerprint (e.g., bioinformatics data, a security password, a personal identification number (PIN), a manual authentication input item, configured authentication information, a digital certificate, or other authentication technology indicating a valid user (e.g., model) has granted permission to use the media content item 104.

In another non-limiting embodiment, the authentication mechanism employed by intake component 130 can include receiving image data of a user independent of or in combination with the signature data such that the image data can be compared with the facial data or other such data within the media content item 104. For instance, a user within a media content item 104 can take a picture of himself using the device 102 (or other device) that captured the media content item 104 (e.g., image) and such image can be compared to the facial data within the media content item 104 in order to authenticate a user (e.g., model). As such, the digital picture comparison technique can serve as a second level of authentication in addition to receiving (e.g., using intake component 130) signature data. Furthermore, in an aspect, upon an identification (e.g., using identification component 110) of a sufficient level of similarities between the media content item 104 data (e.g., facial data) and the captured image of a user (e.g., intake facial data), the authentication level to validate an identity can be satisfied. The more similar data attributes exist then the greater the likelihood that the authentication level is deemed to be greater than a threshold authentication level to indicate a validation of the user identity.

Accordingly, the authentication data verifies the validity of a form of identification received by intake component 130, such as signature data verifying the identity of the signor. Furthermore, authentication data can be coupled to permission data that represents the grant of permissions and/or rights to use, sell, license, offer to sell, reproduce, publish, and perform other activities associated with the media content item 104. In an aspect, authentication data (e.g., received by intake component 130) coupled with permission data can convey the permissions by a verified user (e.g., model) to another party (e.g., user whom generated media content item 104) by a user whom has verified its identity. In another aspect, system 100A can employ a generation component (e.g., described in other embodiments) to generate a window comprising permission data representing a grant of permission by the authorized user to utilize the media content 104 for commercial purposes. Furthermore, a signature box associated with the permission data can be generated and presented (e.g., at a user interface of device 102) to receive (e.g., using intake component 130) signature data corresponding to the permission data. Thus, the signature data (e.g., authentication data) coupled to permission data can represent an execution of an agreement to permit a user to use (e.g., for commercial purposes) media content item 104.

In an aspect, the permission data can directly correspond to media content item 104 and represent statements, language, and text ensuring that an authorized use releases and/or waives any claims of liability against another user (e.g., a permitted user) for the commercial use of a media content item 104 that may include the authorizing users name, image, likeness and/or person (e.g., represented as facial data or body data). Furthermore, the permission data can represent a release and/or waiver of liability by an authorized representative of a product (e.g., represented by object data), or brand (e.g., associated with brand data) asset within the media content item 104. As such, any of a variety of authorized parties can input data (e.g., authentication data) at a device 102 to be received by intake component 130 and coupled with permission data granting permission to use the item in the media content 104 for a commercial use.

In yet another aspect, the intake component 130 can integrate, map, combine, and/or merge the media content item 104 data (e.g., facial data) with permission data and authentication data such that each data set is organized in a useful manner. For instance, upon indexing, classifying or ranking one or more media content items 104, those media content items 104 corresponding to permission data and authentication data can be ranked as having greater commercial use, in part, because of the granted rights (e.g., permission data, permission metadata, authentication data, authentication metadata, etc.) associated with such media content items 104. In another aspect, intake component 130 can receive other data including additional input permissions or uses or edits to the customized permission data. For instance, permissions can be expanded or limited. Furthermore, a user granting permissions can request compensation such as a royalty from successful commercialization of the media content item 104. In an aspect, permission data can represent a wide range of data associated with terms of licensing, assigning ownership and/or permitting another user to commercialize a media content item 104.

In a non-limiting embodiment, the system 100A components can be executed by processor 112 in combination with one another. For instance, identification component 110 can identify facial data within a media content item 104 based on a facial recognition algorithm. As an example, a user can capture a digital image (e.g., media content item 104) using camera components of a user device 102. The digital image can be stored at first data store 116 located on the user device 102, a network device (e.g., server), or other such device accessible by system 100A. The user can open application 124 executing on the user device 102 such that application 124 can employ identification component 110 that scans the digital image and identifies faces (e.g., facial data representing faces) within the digital image. In an aspect, identification component 110 can isolate each face identified in the digital image and generate a frame around each face.

Upon identification (e.g., using identification component 110) of the facial data, each face in the digital image can be ranked and prioritized, such that the identification component 110 can identify those subsets of facial data deemed of higher likelihood to require the receipt of authentication data and permission data that grant permissive use of such higher likelihood facial data. In another aspect, application 124 can employ processor 112 to execute tagging component 120 that can assign tag data to the digital image. For instance, tagging component 120 can assign name data to each face based on input data, historical data, comparative facial data models, machine learning data models, and other such mechanisms to determine a name identifier associated with each face. In another aspect, application 124 can employ components to generate a signature field associated with permission information corresponding to the digital image. The signature field can receive (e.g., using intake component 130) signature data and the signature field can be presented at a user interface of user device 102. Furthermore, a user can input signature data into the signature field (which is associated with the permission information) using touch-input data (e.g., signing with a finger, stylus, etc.).

Accordingly, application 124 can employ processor 112 to execute intake component 130 to receive a signature (e.g., authentication data such as signature data) corresponding to the name identifier (e.g., represented by tag data) and permission (e.g., permission data) by the signor to use the digital image for commercial purposes such as selling to an organization that can use the digital image to market, advertise, and/or add value to its brand. All such data (e.g., permissions, authentication, faces, brands, name identifier, etc.) can be associated with the digital image (e.g., media content item 104) as meta data or combinatorial data, or mapped data such that all permission information, authorization information, facial information, and identity image are linked together.

Turning now to FIG. 1B illustrated is a block diagram of an example, non-limiting diagram 100B of a captured image for facial recognition analysis in accordance with one or more embodiments described herein. Repetitive description of like elements employed in other embodiments described herein is omitted for sake of brevity.

In an aspect, diagram 100B illustrates a user device 102 presenting (e.g., using processor 112 to execute a presentation component not illustrated in the drawings) a digital image (e.g., media content item 104) on a user interface 140 (e.g., touch screen). In an aspect, at reference numeral 166, the digital image is captured using a camera hardware component of the user device 102 which captured two facial images in this instance, a first facial image 142 (e.g., represented by first facial data) depicting a first model and a second facial image 144 (e.g., represented by second facial data) depicting a second model. In an aspect, the digital image can be submitted (e.g., media content item 104 data is uploaded) to an assignment profile corresponding to a marketing campaign of an entity (e.g., individual or organization). Upon submission of the digital image to the assignment profile, application 124 of system 100A can employ processor 112 to execute identification component to scan the digital image for recognizable facial data based on a facial recognition algorithm.

Turning now to FIG. 1C illustrated is a block diagram of an example, non-limiting diagram 100C of an identified face within a captured image in accordance with one or more embodiments described herein. Repetitive description of like elements employed in other embodiments described herein is omitted for sake of brevity.

In an aspect, diagram 100C illustrates a user device 102 presenting (e.g., using processor 112 to execute a presentation component not illustrated in the drawings) a digital image (e.g., media content item 104) on a user interface 140 (e.g., touch screen). In an aspect, the digital image is captured using a camera hardware component of the user device 102 which captured two facial images in this instance, a first facial image 142 (e.g., represented by first facial data) depicting a first model and a second facial image 144 (e.g., represented by second facial data) depicting a second model within the captured digital image. In an aspect, the digital image can be submitted (e.g., media content item 104 data is uploaded) to an assignment profile corresponding to a marketing campaign of an entity (e.g., individual or organization). Upon submission of the digital image to the assignment profile, application 124 of system 100A can employ processor 112 to execute identification component 110 to scan the digital image for recognizable facial data based on a facial recognition algorithm.

In another aspect, the identification component 110 can also identify the facial images in the digital image based on the image scanning employing a facial recognition algorithm. For instance, first facial image 142 is identified (e.g., using identification component 110) as indicated by the brackets framed around area 146 corresponding to first facial image 142. Thus, at reference numeral 168, a first facial image 142 is identified (e.g., using identification component 110). In another aspect, determination component 210 can determine whether the identified facial data is partial facial data or complete facial data. For instance, first facial image 142 can be identified (e.g., using identification 110) and determined (e.g., using determination component 210) to represent complete facial data based on an evaluation of the presence of symmetrical facial features (e.g., two eyes, complete nose, full mouth, full hairline, etc.).

In another instance second facial image 144 can be identified (e.g., using identification component 110 and determined (e.g., using determination component 210) to represent incomplete facial data based on an evaluation of the absence of symmetrical facial features (e.g., one eye, side profile of nose, side profile of mouth, side profile of hairline, etc.). Furthermore, determination component 210 can determine the importance or hierarchical priority of receiving permission data and authentication data associated with one subset of facial data over another based on likelihood of a models “likeness” used in the digital image. In an instance, determination component 210 can determine that first facial data associated with first facial image 142 requires a greater priority for receiving permission data and authentication data rather than second facial data associated with second facial image 144. As such, determination component 210 can base such priority determination on the greater recognition criteria available to associate with likeness of the person depicted by first facial image 142 over second facial image 144 given that more facial attributes are depicted and the complete face can be viewable in the digital image. In another aspect, determination component 210 can base such priority determinations on other factors as well such as the ratio of the facial image size to the digital image total area, nexus of each facial image to a good, service or brand being advertised, and other such criteria.

Turning now to FIG. 1D illustrated is a block diagram of an example, non-limiting diagram 100D of a tagged and identified face within a captured image in accordance with one or more embodiments described herein. Repetitive description of like elements employed in other embodiments described herein is omitted for sake of brevity.

In an aspect, diagram 100D illustrates a user device 102 presenting (e.g., using processor 112 to execute a presentation component not illustrated in the drawings) a digital image (e.g., media content item 104) on a user interface 140 (e.g., touch screen). In an aspect, the digital image is captured using a camera hardware component of the user device 102 which captured two facial images in this instance, a first facial image 142 (e.g., represented by first facial data) and a second facial image 144 (e.g., represented by second facial data). In an aspect, the digital image can be submitted (e.g., media content item 104 data is uploaded) to an assignment profile corresponding to a marketing campaign of an entity (e.g., individual or organization). Upon submission of the digital image to the assignment profile, application 124 of system 100A can employ processor 112 to execute identification component 110 to scan the digital image for recognizable facial data based on a facial recognition algorithm.

In another aspect, the identification component 110 can also identify the facial images in the digital image based on the image scanning employing a facial recognition algorithm. For instance, first facial image 142 is identified (e.g., using identification component 110) as indicated by the brackets framed around first facial image 142. In another aspect, determination component 210 can determine whether the identified facial data is partial facial data or complete facial data. For instance, first facial image 142 can be identified (e.g., using identification 110) and determined (e.g., using determination component 210) to represent complete facial data based on an evaluation of the presence of symmetrical facial features (e.g., two eyes, complete nose, full mouth, full hairline, etc.).

In another instance second facial image 144 can be identified (e.g., using identification component 110 and determined (e.g., using determination component 210) to represent incomplete facial data based on an evaluation of the absence of symmetrical facial features (e.g., one eye, side profile of nose, side profile of mouth, side profile of hairline, etc.). Furthermore, determination component 210 can determine the importance or hierarchical priority of receiving permission data and authentication data associated with one subset of facial data over another based on likelihood of a models “likeness” used in the digital image. In an instance, determination component 210 can determine that first facial data associated with first facial image 142 requires a greater priority for receiving permission data and authentication data rather than second facial data associated with second facial image 144. As such, determination component 210 can base such priority determination on the greater recognition criterial available to associate with likeness of the person depicted by first facial image 142 over second facial image 144 given that more facial attributes are depicted and the complete face can be viewable in the digital image. In another aspect, determination component 210 can based such priority determinations on other factors as well such as the ratio of the facial image size to the digital image total area, nexus of each facial image to a good, service or brand being advertised, and other such criteria.

In another aspect, processor 112 of device 102 can execute tagging component 120 that assigns tag data to facial data. For instance, in an aspect, a user can tap the user interface 140 of device 102 within area 146 depicting first facial image 142. As such, application 124 can receive input data associated with the user tapping, where such input data represents confirmation that first facial image 142 is representing a face. In another aspect, processor 112 of device 102 can execute tagging component 120 to assign tag data to first facial image 142, such as a name of the person depicted by the first facial image 142. In an aspect, the tag data can be automatically assigned (e.g., using tagging component 120) to the first facial image 142 or can be assigned based on user input (e.g., a user tapping a selection or inputting name data representing alphanumeric characters at the user interface 140) received at the user interface 140 in connection with intake component 130. As such, at reference numeral 172, a user can tap the user interface 140 around area 146 thus transmitting confirmation data (e.g., received by intake component 130) that first facial image 142 depicts a face. Furthermore, at reference numeral 172, the user can input tag data (e.g., received by intake component 130) for assignment (e.g., using tagging component 120) to the first facial data. Accordingly, upon receiving confirmation data and assigning tag data, the system can proceed to generating permission data within a model release form format.

Turning now to FIG. 1E illustrated is a block diagram of an example, non-limiting diagram 100E of document data for execution in association with the captured image in accordance with one or more embodiments described herein. Repetitive description of like elements employed in other embodiments described herein is omitted for sake of brevity.

In an aspect, diagram 100E illustrates a user device 102 presenting (e.g., using processor 112 to execute a presentation component not illustrated in the drawings) a digital image (e.g., media content item 104) on a user interface 140 (e.g., touch screen). In an aspect, the digital image is captured using a camera hardware component of the user device 102 which captured two facial images in this instance, a first facial image 142 (e.g., represented by first facial data) and a second facial image 144 (e.g., represented by second facial data). In an aspect, the digital image can be submitted (e.g., media content item 104 data is uploaded) to an assignment profile corresponding to a marketing campaign of an entity (e.g., individual or organization). Upon submission of the digital image to the assignment profile, application 124 of system 100A can employ processor 112 to execute identification component 110 to scan the digital image for recognizable facial data based on a facial recognition algorithm.

In another aspect, the identification component 110 can also identify the facial images in the digital image based on the image scanning employing a facial recognition algorithm. For instance, first facial image 142 is identified (e.g., using identification component 110) as indicated by the brackets framed around first facial image 142. In another aspect, determination component 210 can determine whether the identified facial data is partial facial data or complete facial data. For instance, first facial image 142 can be identified (e.g., using identification 110) and determined (e.g., using determination component 210) to represent complete facial data based on an evaluation of the presence of symmetrical facial features (e.g., two eyes, complete nose, full mouth, full hairline, etc.).

In another instance second facial image 144 can be identified (e.g., using identification component 110 and determined (e.g., using determination component 210) to represent incomplete facial data based on an evaluation of the absence of symmetrical facial features (e.g., one eye, side profile of nose, side profile of mouth, side profile of hairline, etc.). Furthermore, determination component 210 can determine the importance or hierarchical priority of receiving permission data and authentication data associated with one subset of facial data over another based on likelihood of a models “likeness” used in the digital image. In an instance, determination component 210 can determine that first facial data associated with first facial image 142 requires a greater priority for receiving permission data and authentication data rather than second facial data associated with second facial image 144. As such, determination component 210 can base such priority determination on the greater recognition criteria available to associate with likeness of the person depicted by first facial image 142 over second facial image 144 given that more facial attributes are depicted and the complete face can be viewable in the digital image. In another aspect, determination component 210 can based such priority determinations on other factors as well such as the ratio of the facial image size to the digital image total area, nexus of each facial image to a good, service or brand being advertised, and other such criteria.

In another aspect, processor 112 of device 102 can execute tagging component 120 that assigns tag data to facial data. For instance, in an aspect, a user can tap the user interface 140 of device 102 within area 146 depicting first facial image 142. As such, application 124 can receive input data associated with the user tapping, where such input data represents confirmation that first facial image 142 is representing a face. In another aspect, processor 112 of device 102 can execute tagging component 120 to assign tag data to first facial image 142, such as a name of the person depicted by the first facial image 142. In an aspect, the tag data can be automatically assigned (e.g., using tagging component 120) to the first facial image 142 or can be assigned based on user input (e.g., a user tapping a selection or inputting name data representing alphanumeric characters at the user interface 140) received at the user interface 140 in connection with intake component 130.

Furthermore, in an aspect, user device 102 (e.g., smart phone) in connection with application 124 can employ processor 112 to execute intake component 130 to receive authentication data coupled with permission data and based in part on the tag data. For instance, processor 112 can execute generation component 310 to generate permission data representing a series of text lines that grant permission to use the first facial data 142 and releases liability for use of first facial data 142. In another aspect, processor 112 can execute intake component 130 to input signature data (e.g., a form of authentication data) that is coupled to the permission data (e.g., series of text lines or release document) where the signature data is input by the person depicted by first facial data 142 or an authorized individual to provide permission associated with first facial data 142 (e.g., a parent or guardian).

In an instance, generation component 310 can generate the permission data in a format that is presented at user interface 140 of device 102 as a pop-up box that forms in the foreground over the digital image such that the facial data and other elements of the digital image fall to the background (e.g., first facial image 142 and second facial image 146) and the permission data in the form of a model release form appear at the foreground. In an aspect, a user can enter signature data (e.g., using finger to sign a signature on the user interface 140 of user device 102) using a finger, stylus, keyboard or other input mechanism associated with user device 102. Furthermore, in an aspect, intake component 130 can receive such input data (e.g., signature data) representing authentication data and store such data at a remote (e.g., memory 108) or networked location (e.g., first data store 116 in some instances) in connection with first facial image 142, identification data, tag data, media content item 104 data and other such data. As such, at reference numeral 182, the image is depicted as falling in the background behind the model release form 184 represented by permission data. Furthermore, at reference numeral 184, the model release form 184 is depicted that pops-up in the foreground of the display of device 102 thus facilitating a model person to review the permission language associated with the permission data. At reference numeral 186, the model person (associated with first facial image 142) can input signature data by signing the model release form with a finger and transmitting such signature data for receipt by intake component 130.

Turning now to FIG. 1F illustrated is a block diagram of an example, non-limiting diagram 100F of a captured logo image in accordance with one or more embodiments described herein. Repetitive description of like elements employed in other embodiments described herein is omitted for sake of brevity.

In an aspect, FIG. 1F can employ all the aspects disclosed in FIGS. 1A-1E and furthermore can include a capturing of a branding element such as a logo in the digital image (e.g., media content item 104). For instance, a user can tap a logo region 196 (presented at a user interface 140) within the digital image and intake component 130 can receive such input data. Furthermore, in an aspect, identification component 110 can identify the brand data (e.g., logo 150) corresponding to the logo region 196 based on the input data received by intake component 130. In another aspect, the logo can be assigned tag data (e.g., using tagging component 120) such that the logo (e.g., company, product associated with the symbol, etc.) has an identifier or description associated with the symbol. In an aspect, the identified logo within a digital image can be classified within an assignment profile based on the identification data. For instance, a brand for a clothing company can be represented by a logo and the identification of such logo 150 within a digital image can indicate that such digital image can be mapped to an assignment profile associated with such clothing company. In another aspect, the identified brand data can be utilized in for grouping (e.g., using machine learning component 410 described below) and labelling with other similar media content items 104 comprising similar brand data. In an aspect, at reference numeral 192, a user can tap an identified logo or branding item captured in a digital image, wherein the tapping of the user interface 140 at logo region 196 transmits confirmation data that the logo is confirmed to be a logo or brand item.

In another aspect, the identified brand data (e.g., logo 150) can be combined (e.g., using modification component 510) with other data points or subsets (e.g., tag data, facial data, etc.) to be utilized to allow for easier and efficacious access of a series of data associated with a media content item 104. For instance, the more data points that correspond to a media content item 104 and the ability of such data points to integrate (e.g., via mapping, merging databases, providing a unified representation of the data, etc.) with one another allows for a greater number of access points a memory controller can utilize for requesting access to a media content item 104. As such, system 100A and other system embodiments can access combinatorial data comprising several data points (e.g., metadata) associated with a media content item 104 thus providing data storage efficiencies and data retrieval efficiencies. In an instance, the combinatorial data utilized to access a media content item 104 and analyze patterns, similarities and trends associated with such media content item 104 and new media content items can provide storage efficiencies by allowing for storage (e.g., at first data store 116 or memory 108) resulting in a lower operational cost and allowing for more free capacity within a storage device. Furthermore, such combinatorial data can be compressed de-duplicated and conserve space when in storage to allow for a greater storage efficiency based on use of such combinatorial data.

Turning now to FIG. 1G illustrated is a block diagram of an example, non-limiting diagram 100G of document data for execution in association with the captured logo in accordance with one or more embodiments described herein. Repetitive description of like elements employed in other embodiments described herein is omitted for sake of brevity.

In an aspect, FIG. 1G can employ all the aspects disclosed in FIGS. 1A-1F and furthermore can include an intake component 130 that intakes authentication data, permission data, and/or confirmation data associated with the identified brand data (e.g., logo 150). In another instance, generation component 310 can generate a confirmation form 152 comprising confirmation data that enables a user to confirm that the identified logo is consistent with an assignment profile accepting media content items 104 comprising the logo 150 for candidacy in a marketing campaign conducted by an organization. In another aspect, the generation confirmation form 152 can appear at user interface 140 of device 102 in the foreground over the identified logo. Furthermore, in an aspect, the identified logo can be transparently identified in the background such that confirmation form 152 appears transposed over the logo 150 in the background.

In yet another aspect, confirmation form 152 can employ a signature block that receives signature data associated with the confirmation form (e.g., including confirmation text representing the logo 150 within the media content item 104 is a defined logo corresponding to an assignment profile). In an instance, a user can utilize a finger (e.g., touch), stylus, keyboard or other input component to enter signature data into user interface 140 for receipt by intake component 130. Accordingly, the authentication data (e.g., signature data in an instance) can be coupled with other data subsets associated with media content item 104 such as logo identification data, facial data, tag data, brand data, and other such media content item 104 data. In an aspect, at reference numeral 197, the digital image can fall to the background, behind the confirmation form 198. In another aspect, the confirmation form 198 can pop-up and comprise confirmation data that represents confirmation language that a user (e.g., the individual capturing the digital image) can read. As such, the confirmation language can represent that the logo captured in the image is confirmed to be a target logo. At reference numeral 199, a user can sign the confirmation form by inputting signature data with a finger at user interface 140 thus authenticating the confirmation form. The authentication data can indicate that a user confirms that the logo or branding item captured in the digital image is consistent with an assignment profile requirements or request.

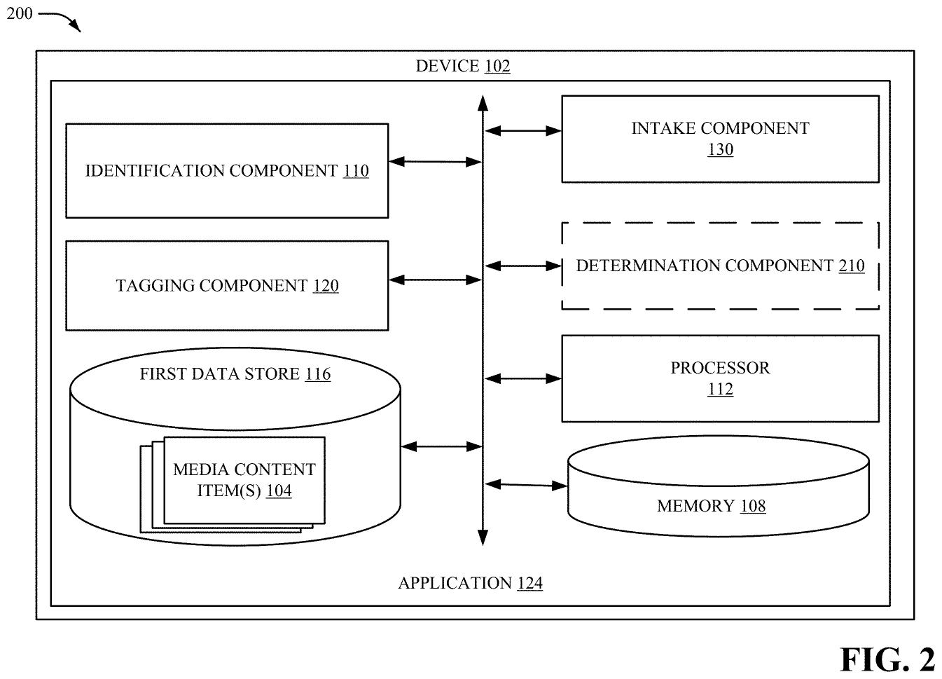

Turning now to FIG. 2, illustrated is a block diagram of an example, non-limiting system 200 that can determine whether identified facial data is partial facial data or complete facial data and retrieve permissions associated with usage of media content items including facial data or incomplete facial data in accordance with one or more embodiments described herein. Repetitive description of like elements employed in other embodiments described herein is omitted for sake of brevity.

In an aspect, system 200 can include one or more components of systems 100A-G and can operate on one or more device including device 102 (e.g., a smart phone). In an aspect, system 200 can comprise or otherwise access (via a network) first data store 116 that stores media content item(s) 104. In an aspect, system 200 can comprise processor 112 and memory 108. In an aspect, processor 112 can execute the computer executable components and/or computer instructions stored in memory 108. The components of system 200 can include identification component 110, tagging component 120, and intake component 130. In an aspect, one or more of the components of system 200 can be electrically and/or communicatively coupled to one or more devices of system 200 or other embodiments to perform one or more functions described herein.

In an aspect system 200 can comprise a memory 108 that stores computer executable components and a processor 112 that executes the computer executable components stored in the memory 108. In an aspect, memory 108 can store identification component 110, tagging component 120, and intake component 130. Furthermore, system 200 can employ application 124, which in an embodiment, can be a software application capable of initiation on a device (e.g., user device such as a mobile phone, tablet, computer, etc.). In an aspect, the initiation of the application can include the starting, initiating, launching, or running or triggering of the application and one or more system components executed by the processor and associated with the application. In another aspect, system 200 can comprise a first data store 116 where media content item(s) 104 can be stored. In yet another embodiment, system 200 can also include determination component 210. Furthermore, the various embodiments described herein can be implemented in connection with any computer or server device, which can be deployed as part of a computer network or in a distributed computing environment. This includes, but is not limited to, an environment with server computers and client computers deployed in a network environment or a distributed computing environment, having remote or local storage.

In another aspect, system 200 can employ processor 112 to execute determination component 210 that determines whether the identified facial data is partial facial data or complete facial data based on a comparison of a first area occupancy associated with the identified facial data to a second area occupancy associated with an entire display area of the media content item. In an aspect, determination component 210 in connection with identification component 110 can determine the identified facial data within media content item 104 having a greater likelihood of requiring a receipt (e.g., from intake component 130) of authentication data (e.g., a digital signature) or permission data (e.g., grant of a license or documented permission terms). As such, the user device 102 can present at its user interface a signature block and permission terms customized to the higher priority users associated with facial data of the media content item 104 before less prioritized facial data.

In an aspect, determination component 120 can determine the priority of facial data by quantifying elements of facial data such as the area of a digital image occupied by each subset of facial data belonging to a respective user as compared to the total area of the digital image. For instance, a first area of first facial data corresponding to a first user captured in a digital image can be quantified as X pixel units and a second area of second facial data corresponding to a second user captured in the digital image can be quantified as Y pixel units. Furthermore, the total pixels corresponding to the digital image can be Z pixel units, where Z is greater than or equal to X+Y. In another aspect, X can be greater than Y. For instance, X pixel units can represent an entire frontal portion (e.g., captures two eyes, two ears, the entire mouth, and nose) of the first users face and Y pixel units can represent an angled side profile (e.g., captures only a portion of the nose, one eye, one ear, and a side face portion) of a second users face.

As such, the likeness of the first user can be more readily discernable in the digital image over the likeness of the second user. Accordingly, determination component 120 can determine that first facial data belonging to the first user should be presented with an opportunity to input authentication data (e.g., digital signature) and customized permission data associated with the first user due to the greater prevalence of likeness of the first user in relation to the commercial value of the digital image. Furthermore, in an aspect, determination component 210 can determine that the ratio of X to Z is greater than the ratio of Y to Z thus leading to a determination that the first facial data associated with X pixel units should be presented with the opportunity to input authentication data and customized permission data. Thus, determination component 210 can determine the likelihood of importance of a subset of facial data against other subsets of facial data based on the completeness of the face representation corresponding to respective subsets of facial data (e.g., a determination along a spectrum of partial/incomplete face representations versus more complete/entire face representations). Furthermore, intake component 130 can receive such authentication data and customized permission data and identification component 110 can compare identification data with tag data (e.g., name data) to determine a user identity.

In another aspect, determination component 210 can make determinations that enable a hierarchical prioritization or ranking (e.g., using a ranking component disclosed below) of data subsets within a media content item 104 for requesting permission data and authentication data. In an aspect, determination component 210 can effectuate such determinations by quantifying other facial data elements such as quantity of a visibility level of facial features (e.g., faces obfuscated by other elements in a digital image, blurriness, facial clarity, etc.), facial profile viewpoint (e.g., side profile of a face captured, front profile of a face captured, etc.), identification of facial accessories (e.g., glasses, scarf, earrings, head covering, etc.), lighting components to an image (e.g., brightness), standardization of facial data (e.g., image representation of face capable of comparison to other image representations based on quality of image data), location of facial landmarks (e.g., hairline data, nose data, etc.), cross-comparative analysis of face data from a model in different digital images (e.g., aging of face, weight loss/gain, surgical modifications to face, etc.), facial expression analysis, gesture analysis, pose analysis, facial and speech analysis (e.g., video data and/or audio data), directed visual processing, face recognition unit analysis, and other such facial data elements. Accordingly, determination component 210 can determine, based on an analysis of such data, the likelihood that a user associated with the candidate data has a likeness that is germane or sufficiently related to the commercial value of the media content item 104 or a determination that a significant likeness of a user is represented in the subject media content item 104.

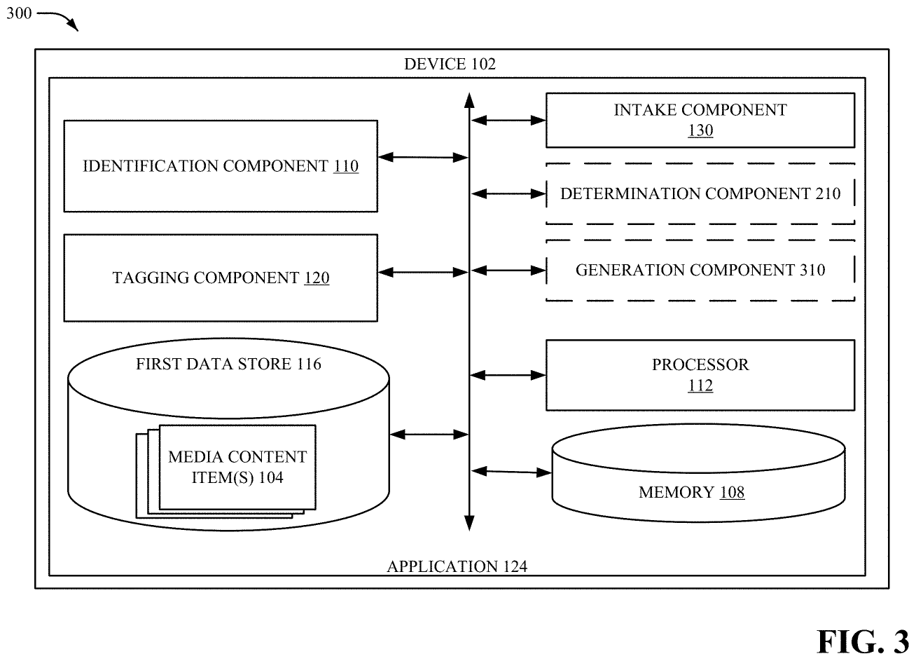

Turning now to FIG. 3, illustrated is a block diagram of an example, non-limiting system 300 that can generate document data and retrieve permissions associated with usage of media content items in accordance with one or more embodiments described herein. Repetitive description of like elements employed in other embodiments described herein is omitted for sake of brevity.

In an aspect, system 300 can include one or more components of system 100A-G and/or 200 and can operate on one or more device including device 102 (e.g., a smart phone). In an aspect, system 300 can comprise or otherwise access (via a network) first data store 116 that stores media content item(s) 104. In an aspect, system 300 can comprise processor 112 and memory 108. In an aspect, processor 112 can execute the computer executable components and/or computer instructions stored in memory 108. The components of system 300 can include identification component 110, tagging component 120, intake component 130, and/or determination component 210. In an aspect, one or more of the components of system 300 can be electrically and/or communicatively coupled to one or more devices of system 300 or other embodiments to perform one or more functions described herein.

In an aspect system 300 can comprise a memory 108 that stores computer executable components and a processor 112 that executes the computer executable components stored in the memory 108. In an aspect, memory 108 can store identification component 110, tagging component 120, and intake component 130. Furthermore, system 300 can employ application 124, which in an embodiment, can be a software application capable of initiation on a device (e.g., user device such as a mobile phone, tablet, computer, etc.). In an aspect, the initiation of the application can include the starting, initiating, launching, or running or triggering of the application and one or more system components executed by the processor and associated with the application. In another aspect, system 300 can comprise a first data store 116 where media content item(s) 104 can be stored. In yet another embodiment, system 300 can also include generation component 310. Furthermore, the various embodiments described herein can be implemented in connection with any computer or server device, which can be deployed as part of a computer network or in a distributed computing environment. This includes, but is not limited to, an environment with server computers and client computers deployed in a network environment or a distributed computing environment, having remote or local storage.

In an aspect, application 124 of system 300 can employ processor 112 to execute generation component 310 (e.g., comprising instructions stored at memory 108) that generates the permission data that represents at least one of a waiver of liability associated with use of the identified facial data, permission to use, sell, or license the identified facial data, or permission to reproduce the media content item. In an aspect, generation component 310 can generate permission data that permits a party (e.g., person owning the device in which the media content item 104 is captured and/or stored). Furthermore, the permission data can represent a grant (e.g., to the creator of the media content item 104) of the right to use and/or own the media content item 104 for use in an unlimited or limited manner. In an aspect, processor 112 can execute commands instructed by generation component 310 to generate a permission granting document (e.g., represented by permission data) based on data and/or metadata from media content item 104 and/or input data.

In an aspect, the document can comprise customized terms and permissions related to the media content item 104, identification data, facial data, brand data, and/or object data. For instance, the generation component 310 can utilize identification data (e.g., generated using identification component 110) to identify in the permission data (e.g., via a term or text in the document) whether to generate permission data corresponding to a subset of object data (e.g., product, good, service), a brand (e.g., logo, symbol, design), or a person (e.g., a face of a person) and located within the media content item 104. Furthermore, generation component 310 in connection with determination component 210 can determine relevant permission language and text to include in a document granting permissions to use the media content item 104 for commercial uses based on the subject subset of data. Accordingly, generation component 310 can generate the permission data and document data such that a document is generated and presented (e.g., using a presentation component not illustrated in FIG. 3) at a user interface of user device 102.

As such, in a non-limiting embodiment, application 124 can employ generation component 310 to utilize relevant data generated, accessed, or stored by identification component 110, tagging component 120 (e.g., name data assigned to facial data, product name data assigned to object data, logo or entity data assigned to a logo or symbol, etc.), and media content item 104 data stored in first data store 116 to generate and present a document capable of receiving (e.g., using intake component 130) signature data to execute a grant of customized permissions for relevant commercial purposes. Thus, a user can capture a digital image using a camera of user device 102, one or more features of the digital image can be identified (e.g., using identification component 110) such as faces (e.g., facial data) or a logo on a product (e.g., brand data and object data).

Furthermore, application 124 can employ processor 112 to execute tagging component 120 to assign descriptive or identifying tag data to the identified element of media content item 104 (e.g., face, product, logo, etc.). In an aspect, determination component 210 can determine the elements of the media content item 104 that is most likely to require permission to commercially use the media content item 104. For instance, complete facial data that occupies a greater portion of the digital image can be determined (e.g., using determination component 210) to require permissions to use the likeness associated with the model who's face is captured. Thus, application 124 can employ processor 112 to execute generation component 310 to generate a document represented by permission data to grant permissions targeted to the media content item 104 and the complete face data identified, tagged, and determined to require a likelihood of requiring permissions to use commercially.

Furthermore, generation component 310 can generate customized data that grants particular permissions based on the face data, intended use of the media content item 104, and likeness of the face data, object data, or brand data around which permissions are sought. In yet another aspect, application 124 can employ processor 112 to execute intake component 130 to receive a signature (e.g., signature data) corresponding to the document and permission terms (e.g., coupled to permission data) to effectuate the grant of permissions. All such permission data, authentication data, facial data, determination data, media content item 104 data, and metadata can be mapped, integrated, and/or stored together to bundle the attributes associated with such data points in a location and a unified manner. In another non-limiting aspect, the generation component 310 can generate permission data customized to a target user, a target type of media content item 104 (e.g., video file, image file, audio file, etc.), a target purpose (e.g., selling, licensing, offering for sale, sub-licensing, reproduction, waiver of liability, etc.).

In an aspect, a user can utilize system 300 (or other embodiments disclosed herein) by opening an application (e.g., application 124) stored at a memory (e.g., memory 108) of a smart phone (e.g., user device 102). The user can tap on a digital image (e.g., media content item 104) stored at a database on a server or on the smart phone (e.g., first data store 116). The application can access the digital image from the storage location (e.g., remote or virtual) and identify (e.g., using identification component 110) faces (e.g., facial data) within the digital image. Furthermore, the user of the smart phone can tap the identified face (e.g., identified facial data representing a model) of a friend, family member, social media user, or other person sought after for obtaining the release. The user can assign (e.g., using tagging component 120) an identifier such as a name (e.g., tag data) to the target identified face in the digital image. Upon such tap and tagging of the face, the application can generate (e.g., using generation component 310) a signature box presented at a user interface of the smart phone (e.g., user device 102). The target user who's face is presented within the digital image can sign the signature box and such signature (e.g., signature data) is received (e.g., using intake component 130) by the application for storage at a remote or networked data store. In an aspect, the user can scroll a generated (e.g. using generation component 310) document that grants permissions (e.g., permission data) to using the digital image and the signature data can be coupled to the document or is a part of the document.

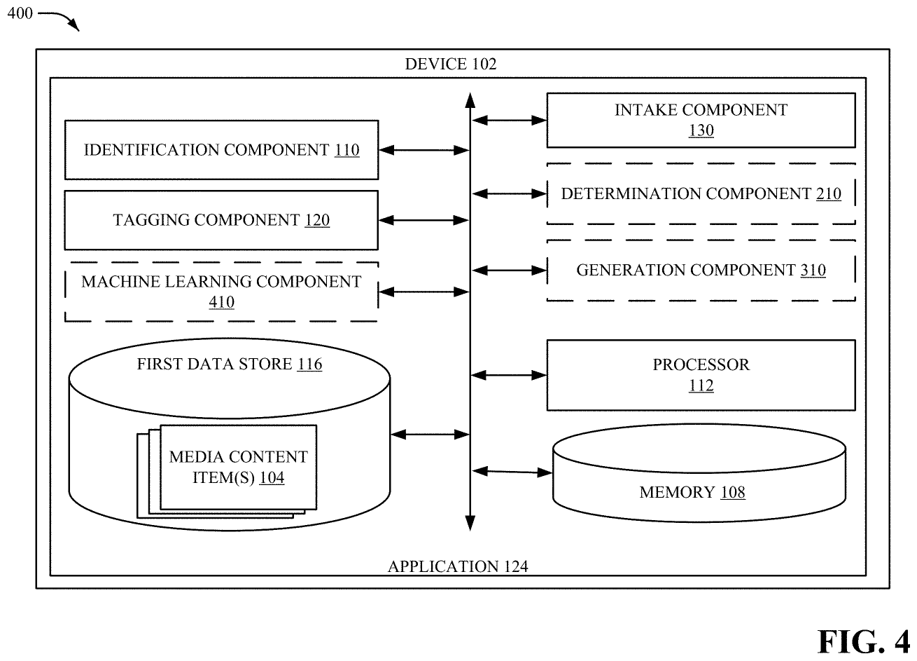

Turning now to FIG. 4, illustrated is a block diagram of an example, non-limiting system 400 that can execute a machine learning model based on identified facial data input and retrieve permissions associated with usage of media content items in accordance with one or more embodiments described herein. Repetitive description of like elements employed in other embodiments described herein is omitted for sake of brevity.

In an aspect, system 400 can include one or more components of system 100A-G, 200, and/or 300 and can operate on one or more device including device 102 (e.g., a smart phone). In an aspect, system 400 can comprise or otherwise access (via a network) first data store 116 that stores media content item(s) 104. In an aspect, system 400 can comprise processor 112 and memory 108. In an aspect, processor 112 can execute the computer executable components and/or computer instructions stored in memory 108. The components of system 400 can include identification component 110, tagging component 120, and intake component 130, determination component 210, and/or generation component 310. In an aspect, one or more of the components of system 400 can be electrically and/or communicatively coupled to one or more devices of system 400 or other embodiments to perform one or more functions described herein. In another aspect, system 400 can further comprise a machine learning component 410 that groups input media content items with defined tag data based on a comparison of the identified facial data coupled to the tag data to the input media content data, wherein a grouping of the input media content items improves an execution efficiency of the processor.

In an aspect, application 124 can employ processor 112 to execute machine learning component 410 to group media content item 104 or data components (e.g., facial data, object data, brand data, etc.) of media content item 104. In an aspect, machine learning component 410 can utilize machine learning models and/or machine learning techniques to group data based on similarities into various classes. For instance, newly generated media content items can be compared to data associated with existing data that is labelled or identified in a manner. For instance, already identified (e.g., using identification component 110) facial data, facial data assigned (e.g., using tagging component 120) tag data (e.g., name descriptors), and/or received (e.g., using intake component 130) signature data can be utilized as training data in a machine learning model. As such, machine learning component 410 can group any new facial data, new tag data, new signature data, new identification data or other such data subsets to the training data in order to efficiently, accurately, and precisely characterize the new data into appropriate classifications.

As a non-limiting example, a new digital image can be uploaded to application 124 on a user smart phone (e.g., device 102). In an aspect, the faces (e.g., facial data), products (e.g., object data), and logos (e.g., brand data) within the digital image can be identified (e.g., using identification component 110). Furthermore, the identified faces, products and logos can be compared for similarities with previously identified faces, products, and logos corresponding to digital images (e.g., media content items 104) stored remotely (e.g., first data store 116) or at a networked location. As such, the new media content item data can be grouped into groups with the stored and archived existing media content item 104 data to group (e.g., using machine learning component 410) into data classifications of already grouped training data. For instance, the new media content item 104 can be grouped by similar tag data with other media content items 104. Furthermore, in an aspect, new media content items 104 can be grouped with other media content items 104 of similar data and similar characteristics within a common assignment profile corresponding to a brand. The similarity between the media content items 104 grouped within an assignment profile can utilize a comparison of policies, rules, requirements, and criteria governing the candidacy of media content items 104 to be grouped within the assignment profile.

In an aspect, machine learning component 410 can compare similarities in the patterns of media content item 104 data and new media content items and employ recognition techniques to recognize patterns between data sets and subsets within respective groups. In another aspect, machine learning component 410 can assign values to data elements of a media content item 104 and compare such values between input media content items and training data, where the training data can comprise archived or stored media content items 104 with identified grouping characteristics corresponding to several data subsets and data sets of system embodiments disclosed herein. Furthermore, machine learning component 410 can compare the similarities between the data values (e.g., raw data values, graphic representations of the data, etc.) to identify matching patterns between the two data value sets or differences in patterns that can inform the grouping operations or non-grouping operations conducted by the processor 112 based on machine learning component 410 instructions.

In a non-limiting embodiment, application 124 can receive (e.g., uploaded) a new digital image as input data. Furthermore, the new digital image can identify elements such as products, faces, and logo's. In another aspect, tags can be automatically populated in association with the identified elements of the digital image. As such, elements of the digital image can be labelled with descriptors (e.g., names of faces, title of products, company's owning products, brand names of products, etc.). Furthermore, permission data can automatically populate as well as signature data (e.g., requires validation or confirmation from an authenticated model) associated with a model who's face is captured in the digital image. In an aspect, a user can confirm the signature data belongs to them and allow the signature data to be coupled to the permission data in order to grand permissions to use the new input digital image. Accordingly, the automatic population of various data sets and labelling of the digital image can be facilitated using identified data and grouped data (e.g., using machine learning component 410) based on a machine learning model.

In an aspect, machine learning component 410 can group facial data based on various facial features such as the size of the eyes, the length of a face, the distance between facial features (e.g., using a vector-based distance representation), face landmark estimation, analyzing gradients (e.g., light to dark analysis) between pixels. Furthermore, in an aspect, machine learning component 410 can utilize the comparisons between unique features of faces between training data of the media content item 104 and media content item input data to group the media content item input data. In another aspect, the grouping (e.g., using machine learning component 410) activities are capable of becoming faster and more accurate over time as the machine learning component 410 evaluates similarities and nuance's between data subsets in a more detailed and efficient manner as well as in association with a growing sample of training data. Furthermore, machine learning component 410 allows for faster access and more efficient access to data associated with media content items 104 due to the precision of the grouping activities from machine learning component 410. In another aspect, processor 112 can execute instructions more efficiently and at a greater speed as a result of accessing and deploying properly classified and easily identified tag data for each new media content item based on comparative similarities with existing and archived media content item 104.

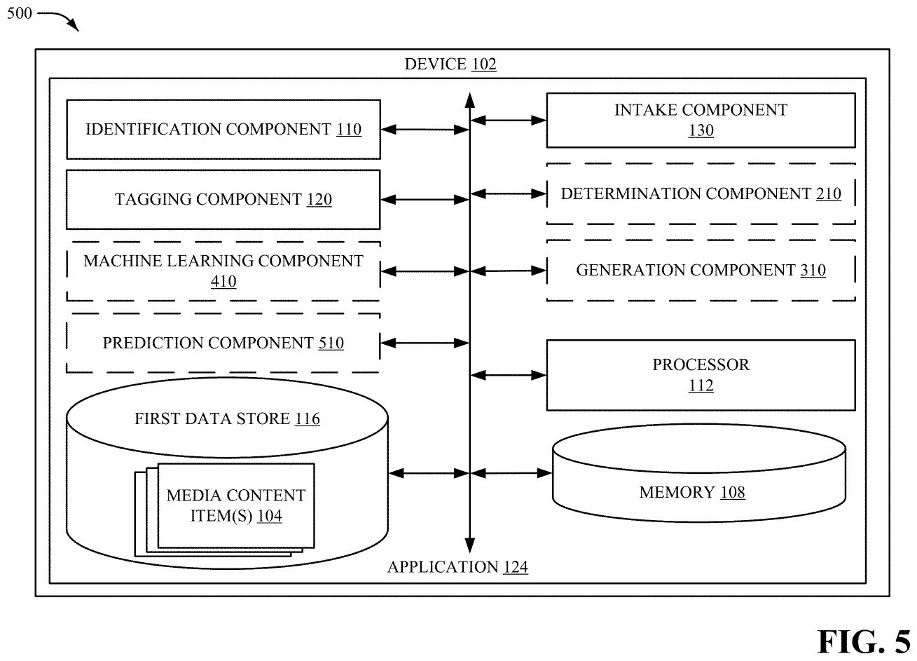

Turning now to FIG. 5, illustrated is prediction component 510 that generates prediction data comprising predictive facial data and predictive identification data associated with another media content item, wherein the another media content item is different from the media content item, wherein the media content item or the another media content item is at least one of an image file, a video file, or an audio file. Repetitive description of like elements employed in other embodiments described herein is omitted for sake of brevity.

In an aspect, system 500 can include one or more components of system 100A-G, 200, 300, and 400 and can operate on one or more device including device 102 (e.g., a smart phone). In an aspect, system 400 can comprise or otherwise access (via a network) first data store 116 that stores media content item(s) 104. In an aspect, system 500 can comprise processor 112 and memory 108. In an aspect, processor 112 can execute the computer executable components and/or computer instructions stored in memory 108. The components of system 500 can include identification component 110, tagging component 120, and intake component 130, determination component 210, generation component 310, machine learning component 410. In an aspect, one or more of the components of system 500 can be electrically and/or communicatively coupled to one or more devices of system 500 or other embodiments to perform one or more functions described herein. In another aspect, system 500 can further comprise a prediction component 510 that generates prediction data comprising predictive facial data and predictive identification data associated with another media content item, wherein the another media content item is different from the media content item, wherein the media content item or the another media content item is at least one of an image file, a video file, or an audio file.

In an aspect, application 124 can employ processor 112 to execute prediction component 510 that generates prediction data comprising predictive facial data and predictive identification data associated with another media content item, wherein the another media content item is different from the media content item 104, wherein the media content item 104 or the another media content item is at least one of an image file, a video file, or an audio file. In an aspect, application 124 can intake (e.g., using intake component 130) new media content items for analysis, to receive permissions, and to utilize in a commercial transaction (e.g., to sell or license). As such, a media content item 104 can be sold or provided to a company and/or entity interested in using the media content item 104 for commercial uses such as advertising, marketing, and promoting its brand or product.

As such, prediction component 510 can generate predictive data representing elements of new media content items that may have a greater likelihood of receiving commercial success or generating greater amounts of revenue. For instance, prediction component 510 can generate predictive data in connection with identification component 110 that facilitates identification of attributes within a digital image that are more likely to contribute to a higher commercial value of the digital image than other attributes. For instance, a digital image may comprise attributes represented by data that include favorable spatial positioning of items within the digital image (e.g., graphics, objects, people, text, etc.), the presence of elements that convey emotion, visibility of important characteristics of the media content item (e.g., determining whether product and/or person of interest clearly visible), appealing subject matter (e.g., capturing a stunt, captivating activity, etc.), attributes that encourage consumers to publish their experiences using the target product (e.g., encouraging an audience to become a co-advertiser with the brand), content with a nexus to other marketing schemes (e.g., contests, participatory engagement opportunities, etc.), content including a celebrity endorsement, content that integrates the voice of the consumer, and other such value creating attributes.

In another aspect, prediction component 510 can generate predictive data that populates identification data, tag data and other elements of a new media content item upon application 124 accessing such new media content item. For instance, prediction component 510 can evaluate hashtags associated with a digital image to map such digital image to other digital images with the same or similar associated hashtags. Furthermore, in an aspect, the prediction component 510 can utilize similarities between digital images that correspond with one another based on a similarity (e.g., hash tag, facial data, etc.) to correlate common data between such images. As such, system 500 components can access relevant data more efficiently and correlate (e.g., assigning tag data to digital images) relevant data based on similarities between new digital images and archived digital images. Furthermore, prediction component 510 can use predictive data techniques to predict the permissions that may be useful in a current media content item based on the permissions that were useful in previous media content items.

In an aspect, prediction component 510 can also utilize any one or more predictive analysis techniques or models to facilitate effective marketing using user generated media content item 104. For instance, prediction component 510 can employ a cluster model to segment target users of a media content item 104 based on a range of variables (e.g., demographics, psychographics, preference data, etc.). In an aspect, prediction component 510 can use any one or more of the following clustering techniques including; behavioral cluster, product-based cluster, and/or brand-based cluster. In another aspect, prediction component 510 can utilize one or more propensity model to predict value propositions associated with a media content item.

For instance, prediction component 510 can facilitate, based on utilizing a media content item 104 in a marketing campaign, a prediction of a consumer's propensity, such as a propensity or likelihood of consumer engagement (e.g., comment on a media content item 104, input a hashtag remark, share the media content item 104, click on an advertisement associated with a media content item 104), propensity of a consumer to purchase an advertised product or service, propensity of a consumer to churn or purchase another product not advertised in the media content item 104, propensity of the media content item 104 to lead to a conversion (e.g., perform an action item such as open an e-mail, respond to a prompt in the media content item 104, perform an on-line task such as providing information, etc.) based on consuming the media content item 104, and other such marketing metrics.

In yet another aspect, prediction component 510 can generate predictive data representing recommendations in connection with media content item 104. For instance, a digital image can be utilized for a marketing campaign or indirectly correspond to a recommendation of a product, service, or advertisement to a consumer. Furthermore, prediction component 510 can generate prediction data associated with recommendation data related to media content item 104 using purchasing behavior data (e.g., accessing structured data associated with media content item 104, assessing social media data, performing behavior scoring of customer data) and such media content item 104 can be utilized to up-sell, cross-sell or next sell recommendations based on generated prediction data.

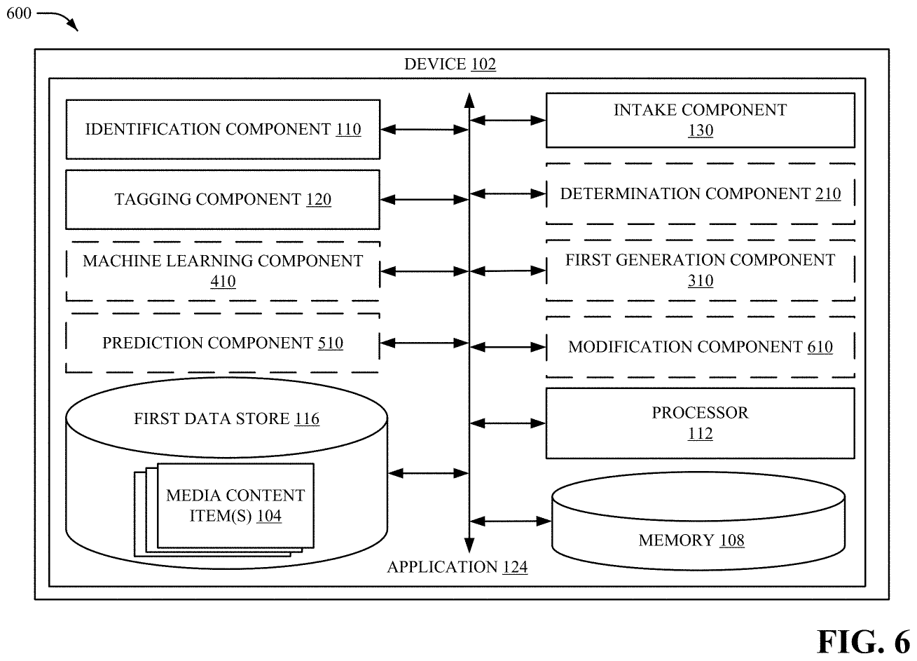

Turning now to FIG. 6, illustrated is a block diagram of an example, non-limiting system 600 that can modify facial recognition data, identification data, and signature data into combinatorial data and retrieve permissions associated with usage of media content items 104 in accordance with one or more embodiments described herein. Repetitive description of like elements employed in other embodiments described herein is omitted for sake of brevity.

In an aspect, system 600 can include one or more components of system 100A-G, 200, 300, 400, and 500 and can operate on one or more device including device 102 (e.g., a smart phone). In an aspect, system 600 can comprise or otherwise access (via a network) first data store 116 that stores media content item(s) 104. In an aspect, system 600 can comprise processor 112 and memory 108. In an aspect, processor 112 can execute the computer executable components and/or computer instructions stored in memory 108. The components of system 600 can include identification component 110, tagging component 120, and intake component 130, determination component 210, generation component 310, machine learning component 410, and/or prediction component 510. In an aspect, one or more of the components of system 600 can be electrically and/or communicatively coupled to one or more devices of system 600 or other embodiments to perform one or more functions described herein. In another aspect, system 600 can further comprise a modification component 610 that modifies the facial recognition data, the identification data, and the authentication data into combinatorial data representing an integration of facial recognition data, identification data, and the authentication data, wherein the combinatorial data facilitates improving a data storage efficiency of the memory.

In an aspect, application 124 can employ processor 112 to execute modification component 610 to modify data associated with media content item 104. In an aspect, modification component 610 can adjust the design patterns used to determine and track data such that the processor 112 can execute tasks that take action based on the adjusted or modified data patterns. In an aspect, generated data associated with a media content item 104 such as identification data, tag data, facial data, brand data and other data can be integrated to exhibit a unique data pattern that maps together respective useful data subsets. In an aspect, modification component 610 can implement one or more approach to integrate changes made to data subsets to interact with software and hardware system layers including application logic layers through physical storage devices. In an aspect, by combining (e.g., using modification component 610) data subsets, memory 108 and/or data store 116 can create storage efficiencies that facilitate system 100A and any embodiment described herein to store and manage data while utilizing a conservative area of space. As such, the storage efficiencies allow for the generation of greater data size to space consumed ratio's.

In an aspect, modification component 610 can also employ storage efficiency technologies such as snapshot technology that stores only changes that occurs between data sets, data deduplication technologies that efficiently track and remove duplicate data blocks (e.g., redundant data such as independent component data that makes up combinatorial data), thin provisioning technologies that allocate resource capacities that are currently unused to an account (e.g., an account profile or a user account). In an aspect, the employment of modification component 610 can result in a decrease in times to backup and restore data associated with media content item 104, reduction of space (e.g., requiring less storage in data store 116) required to store a given amount of data, reducing energy use (e.g., requiring fewer spindles) required to store a defined amount of data, provisioning efficiency that allows for efficient access and transmission of writable copies of media content item 104. Accordingly, modification component 610 modifies data subsets associated with media content item 104 and results in efficiencies to the software and hardware elements of system embodiments described herein.

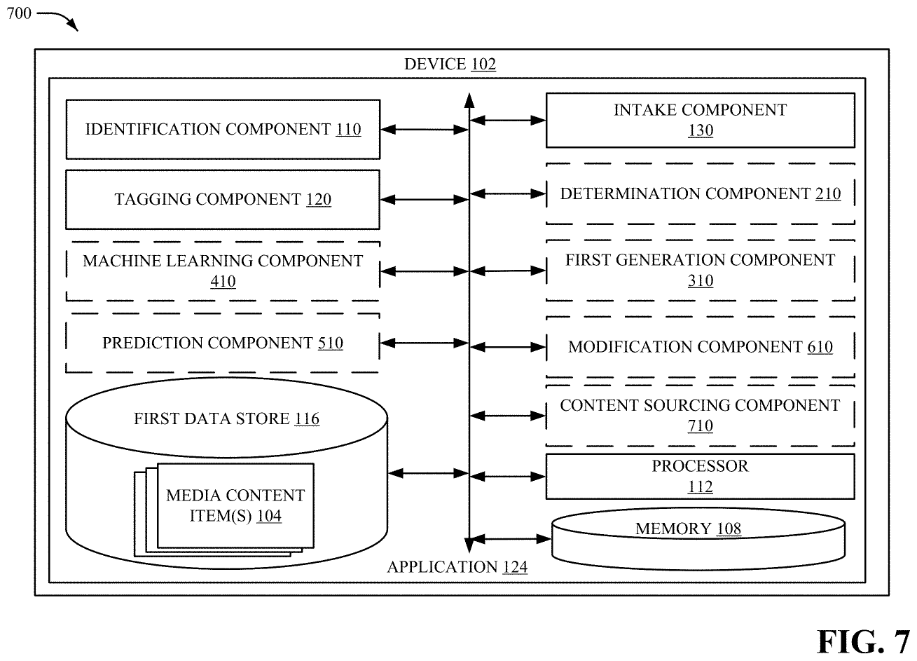

Turning now to FIG. 7, illustrated is a block diagram of an example, non-limiting system 700 that can retrieve a media content item from a data store and retrieve permissions associated with usage of media content items in accordance with one or more embodiments described herein. Repetitive description of like elements employed in other embodiments described herein is omitted for sake of brevity.

In an aspect, system 700 can include one or more components of system 100A-G, 200, 300, 400, 500, and/or 600 and can operate on one or more device including device 102 (e.g., a smart phone). In an aspect, system 700 can comprise or otherwise access (via a network) first data store 116 that stores media content item(s) 104. In an aspect, system 700 can comprise processor 112 and memory 108. In an aspect, processor 112 can execute the computer executable components and/or computer instructions stored in memory 108. The components of system 700 can include identification component 110, tagging component 120, and intake component 130, determination component 210, generation component 310, machine learning component 410, prediction component 510, and/or modification component 610. In an aspect, one or more of the components of system 700 can be electrically and/or communicatively coupled to one or more devices of system 700 or other embodiments to perform one or more functions described herein. In another aspect, system 700 can further comprise content sourcing component 710 that retrieves the media content item 104 from a data store comprising one or more media content items associated with a user-generated content sourcing campaign.

In an aspect, application 124 can employ processor 112 to execute content sourcing component 710 that retrieves the media content item from a data store comprising one or more media content items 104 associated with a user-generated content sourcing campaign. In an aspect, the system 700 can further include a user-generated content sourcing platform that facilitates interactions (e.g., messaging, communication, transmission of data, etc.) between brands (e.g., organizations, entities, companies, etc.) and users (e.g., consumers, fans, artists, profiteers, etc.). In an aspect, the content sourcing platform can aggregate (e.g., uploading to brand assignment profiles) user generated data representing user generated content such as digital images, videos, and audio files such that users can contribute digital images and digital videos to brands for potential use in marketing campaigns and advertising efforts.

In an aspect, processor 112 can execute content sourcing component 710 of system 700 and other system embodiments such that the media content items 104 aggregated using the content sourcing platform can be identified (e.g., using identification component 110, assigned tag data (e.g., using tagging component 120), and coupled with received (e.g., using intake component 130) permission data and authentication data. As such, system 700 and other system embodiments disclosed herein can be integrated with a content sourcing platform, a data store comprising media content item 104 from a content sourcing platform or connected (e.g., remotely or via a network) to a content sourcing platform to access the media content items 104 associated with such platform. In an aspect, the media content item 104 sourced from a content sourcing platform can utilize permission data and authentication data representing a grant of permissions from authorized entities (e.g., copyright holder such as user capturing a digital image, individuals captured within the digital image, etc.) to use the media content item 104 for commercial or non-commercial uses.

As such, system 700 and other system embodiments can ensure a proper chain of title, grant of ownership and grant of permissions associated with user generated media content (e.g., media content items 104). In an aspect, system 700 and other system embodiments facilitates such permission granting by requiring a mere tapping of a user interface of user device 102. Also, the user can assign tag data to the facial data in a digital image. Furthermore, in an aspect, the user can input signature data (e.g., authentication data) and permission data associated with a customized release form (e.g., incorporating user name based on tag data) for correspondence (e.g., as metadata or combinatorial data) with the media content item 104. Thus, a user can provide the media content item 104 including granted permissions to brand entities (e.g., uploading to assignment profiles) for use in the brand entity's print, digital, and/or social media advertising campaigns without concern of liability issues.

In an aspect, the content generation platform and/or system 700 (and other embodiments) can include metadata such as name data, correspondence data (e.g., e-mail, phone number, etc.), content creation date data, content creation time stamp data, content update time stamp data, content creation location data (e.g., latitude and longitudinal data), device type utilized to capture media content item 104 (e.g., make and model of smart phone, tablet, desktop computer, camera), an operating system associated with a device 102 used to capture the media content item 104, and other such metadata. In another aspect, the content sourcing platform can facilitate a brand company to create assignment profiles and such assignment profiles can include data such as name data, correspondence data, company data (e.g., name, address, contact info, website, social media links, etc.), and other such data.

In another aspect, a user (e.g., brand entity) can utilize a content generation platform to create (e.g., using content sourcing component 710) creative brief data representing details regarding a marketing campaign and content submissions sought from users (e.g., photographers, consumers, fans, etc.). Furthermore, a user can generate (e.g., using content sourcing component 710) bounty data that includes requirement data related to the assignment profile and creative brief data. As such the requirement data can represent start date data, end date data, and a pricing model outlining the monetary amount or compensation a brand will provide a user in exchange for a desired media content item 104 submitted under the assignment profile. In another aspect, the media content item 104 can be easily transferred to the brand with authorized (e.g., authentication data) rights (permission data), waived liabilities (e.g., permission data), and consideration (e.g., price paid for the media content item 104) associated with a binding transaction (e.g., executing a release form and/or confirmation form).

In an instance, system 700 and other systems disclosed herein can be integrated with the content sourcing platform in a variety of manners. In an instance, a user can download the application 124 (integrated with the content sourcing platform) to a smart phone or other user device 102. The user can then create (e.g., using content sourcing component 710) an account on the platform and confirm correspondence information (e.g., e-mail address). Furthermore, in an aspect, the user can review an assignment associated with a brand assignment profile. Furthermore, a user can accept (e.g., submit acceptance input information at user interface 140 of user device 102) an assignment, generate a media content item 104 (e.g., digital image, video, etc.) using user device 102, or share an existing media content item 104 (e.g., already captured photograph stored at a remote or networked data store). The user can submit the media content item 104 to the assignment profile and confirm ownership of the media content item 104 (e.g., entering authentication data and permission data, submitting a confirmation form and confirmation data). Furthermore, in an aspect, the media content item 104 can have facial data identified (e.g., using identification component 110), tag data assigned (e.g., using tagging component 120), and receive (e.g., using identification component) authentication data and permission data from a model and other parties with likeness or whose facial data is captured within the digital image.

In another aspect, content sourcing component 710 can source media content items 104 from a range of platforms and deploy its system 700 (and other embodiments) capabilities with such media content items 104 sourced from such platform. For instance, in an aspect, sourcing component 710 can source digital images from a consumer commenting, rating and sharing platform. Accordingly, content sourcing component 710 can retrieve user generated digital images from such platform and scan as well as identify (e.g., using identification component 110) elements (e.g., brand logo's, faces, signature food items, etc.) of the digital images that convey commercial value to various brands. Furthermore, the identified elements can be assigned tag data (e.g., using tagging component 120) that describes respective elements of the digital image. In another aspect, the digital images can be submitted to assignments or can be transmitted to brands to assess the marketability of such digital image. Furthermore, the brand can purchase the digital image directly from a user device (e.g., user smart phone that generated the content). In another aspect, permission data and authentication data can be requested (e.g., using intake component 130) and received from users associated with the facial data in the digital image and/or from users whom own the digital image. As such, platforms storing media content items 104 submitted by users can utilize the systems and methods disclosed herein the obtain permission data and authentication data as well as integrate with systems and techniques for linking brands (e.g., organizations whom seek to create assignment profiles and/or engage in user generated content based marketing campaigns) to users (e.g., users whom create user generated content).

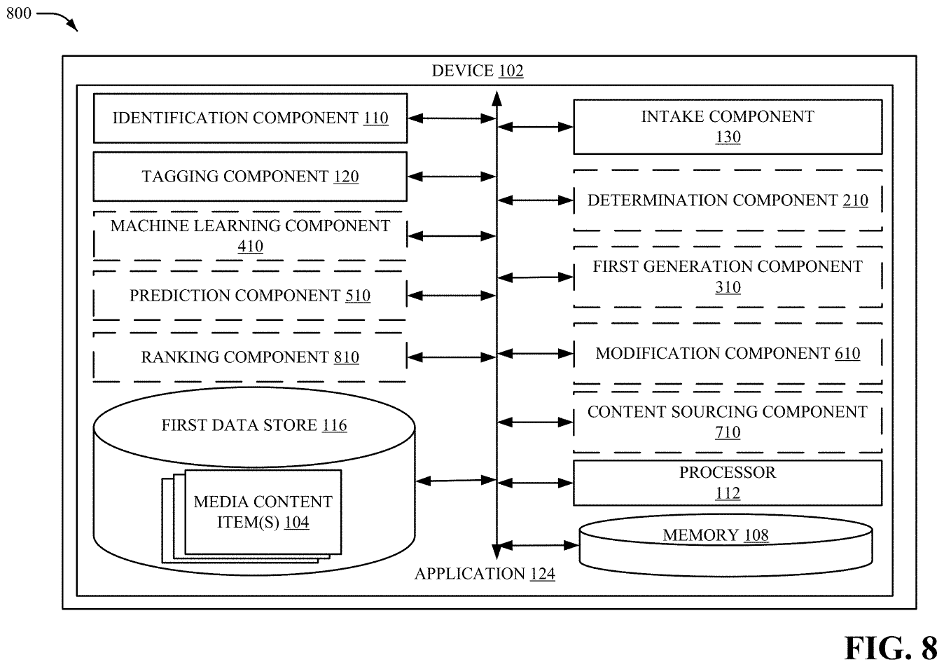

Turning now to FIG. 8, illustrated is a block diagram of an example, non-limiting system 800 that can rank the partial facial data and the complete facial data based on a set of relevancy scores and retrieve permissions associated with usage of media content items in accordance with one or more embodiments described herein. Repetitive description of like elements employed in other embodiments described herein is omitted for sake of brevity.

In an aspect, system 800 can include one or more components of system 100A-G, 200, 300, 400, 500, 600, and/or 700 and can operate on one or more device including device 102 (e.g., a smart phone). In an aspect, system 800 can comprise or otherwise access (via a network) first data store 116 that stores media content item(s) 104. In an aspect, system 800 can comprise processor 112 and memory 108. In an aspect, processor 112 can execute the computer executable components and/or computer instructions stored in memory 108. The components of system 800 can include identification component 110, tagging component 120, and intake component 130, determination component 210, generation component 310, machine learning component 410, prediction component 510, modification component 610, and/or content sourcing component 710. In an aspect, one or more of the components of system 800 can be electrically and/or communicatively coupled to one or more devices of system 800 or other embodiments to perform one or more functions described herein. In another aspect, system 800 can further comprise ranking component 810 that ranks the partial facial data and the complete facial data based on a set of relevancy scores that represent a relevancy of the partial facial data or the complete facial data to a central marketable feature of the media content item 104.

In an aspect, application 124 can employ processor 112 to execute ranking component 810 that ranks a media content item 104 or data subsets corresponding to elements of a media content item 104 for relevancy to central marketable feature, such as a feature associated with a marketing goal (e.g., correlated with an assignment profile of a content sourcing campaign) of a brand entity. In an instance, ranking component 810 can rank facial data within a digital image or video file that is most likely to constitute a use of “likeness” because the facial data has a prevalent role in the digital image, one facial data subset is more recognizable than another facial data subset in the digital image, has a greater relevancy to the central marketable focus of the digital image, and other such rank criteria.

In another aspect, the ranking component 810 can rank the facial data based on a score assigned to each facial data element. For instance, facial data can be scored based on a ratio of the facial data size to the total area of the digital image, the brightness of the facial data in the digital image, the level of completeness of the facial data within the digital image (e.g., entire face or partial face captured in the digital image), and other such variables associated with the use of a person's likeness and the relationship of facial data to the commercial concept portrayed. As such, a scoring component (not illustrated in drawings) can assign a score to several attributes associated with the facial data and such score can be utilized by ranking component 810 to rank a first subset of facial data against a second subset of facial data. For instance, a first subset of facial data associated with partial facial data (e.g., a side profile view of a person's face) can be assigned a first score that is higher than a second score corresponding to a second subset of facial data associated with complete facial data (e.g., a complete and symmetrical front view of a persons face).

In another instance, the first subset of facial data can be assigned a third score based on the picture quality and the second subset of facial data can be assigned a fourth score that is lower than the third score because the quality of the second subset of facial data is blurry as opposed to the crisp quality of the first subset of facial data. Furthermore, the scores can be aggregated and/or weighted in an algorithm to determine the facial data to retrieve permission data and authentication data from as a higher priority. In an aspect, the score assigned to each attribute of the facial data can be a data value (e.g., numeric metric). Furthermore, in an aspect, ranking component 810 can utilize the scores associated with the facial data to rank the facial data and in some instances in connection with other data (e.g., brand data, product data, etc.) for a priority of requesting permission data and/or authentication data. As such, ranking component 810 can aggregate, analyze, and evaluate score data and compare score data associated with each subset of facial data in order to rank and prioritize some facial data over other facial data.

Furthermore, processor 112 can execute ranking component 810 to compare a score associated with the facial data to a threshold score level to eliminate irrelevant facial data from candidacy in the ranking scheme. For instance, if a digital image has hundreds of people in the image (e.g., picture of a commencement ceremony), but facial data associated with one person is quite clear and larger than the rest, then a score associated with all the other individuals may fall below a threshold score and ranking component 810 can either not rank such facial data (corresponding to the hundreds of people that have a lower relevancy to the commercial purpose of the image or less of a likelihood that their “likeness” is used in the image) or rank them low in the priority queue such that permission data and authentication data are less likely a requirement from such people. As such, ranking component 810 can utilize relevancy scores to rank, order and/or prioritize subsets of facial data and users associated with such facial data, from whom, to request permission data and authentication data using system 800 and other embodiments disclosed herein.

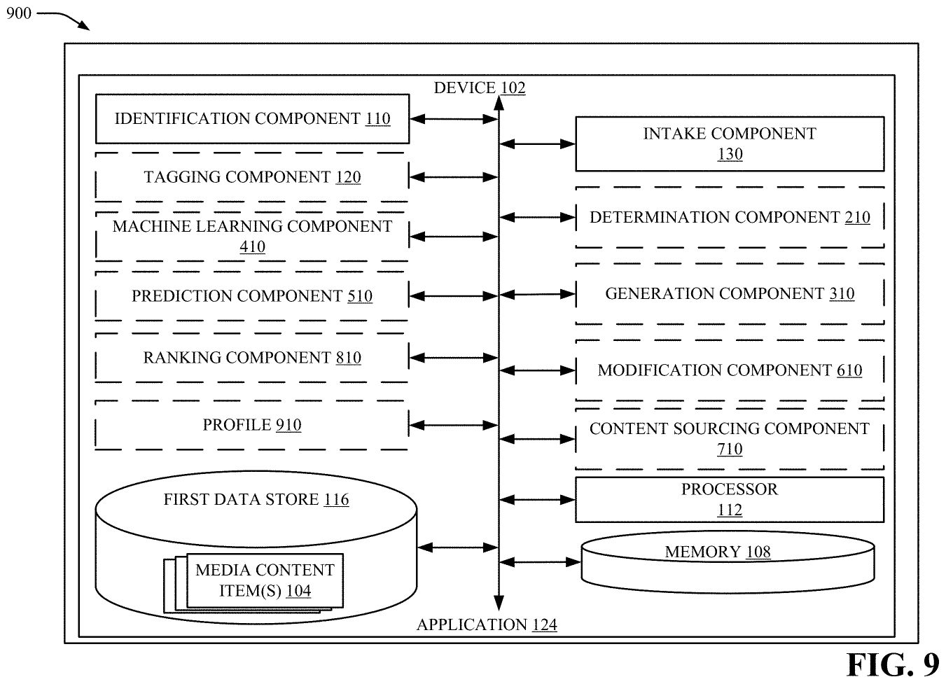

Turning now to FIG. 9, illustrated is a block diagram of an example, non-limiting system 900 that can facilitate a generation of an assignment profile comprising a media content item sourcing framework and retrieve permissions associated with usage of media content items sourced within the media content item sourcing framework in accordance with one or more embodiments described herein. Repetitive description of like elements employed in other embodiments described herein is omitted for sake of brevity.

In an aspect, system 900 can include one or more components of system 100A-G, 200, 300, 400, 500, 600, 700, and/or 800 and can operate on one or more device including device 102 (e.g., a smart phone). In an aspect, system 900 can comprise or otherwise access (via a network) first data store 116 that stores media content item(s) 104. In an aspect, system 900 can comprise processor 112 and memory 108. In an aspect, processor 112 can execute the computer executable components and/or computer instructions stored in memory 108. The components of system 900 can include identification component 110, tagging component 120, and intake component 130, determination component 210, generation component 310, machine learning component 410, prediction component 510, modification component 610, content sourcing component 710, and/or ranking component 810. In an aspect, one or more of the components of system 900 can be electrically and/or communicatively coupled to one or more devices of system 900 or other embodiments to perform one or more functions described herein. In another aspect, system 900 can further comprise a profile component 910 that facilitates a generation of an assignment profile comprising a media content item sourcing framework in accordance with one or more defined policies.

In an aspect, application 124 can employ processor 112 to execute profile component 910 to generate an assignment profile on behalf of a brand, for instance. In an instance, profile component 910 can facilitate a generation of an assignment that is configured to receive (e.g., in connection with intake component 130) media content item 104 generated by users using user devices (e.g., user device 102). In an aspect, the assignment can allow for users and/or consumers to focus on a brand and engage with a brand or organization owning a brand in a meaningful manner by participating in the marketing and advertising efforts conducted by the brand. In an aspect, profile component 910 can generate an assignment profile that requests submission of media content item 104 that are authentic, oriented toward a brand, and/or recognizable to a local market. Furthermore, profile component 910 can facilitate a generation of rules associated with the assignment and/or rewards (e.g., compensation) associated with media content items 104 selected for participation in a marketing campaign.

In an aspect, the organization utilizing profile component 910 to generate an assignment can gain access to loyal fans, creative and original content (e.g., media content items 104), and have permissive rights associated with the media content items 104, and data associated with such media content item 104 (e.g., contact data, facial data, identification data, submission data, etc.). Furthermore, the generation (e.g., using profile component 910) of an assignment, provides a brand the opportunity to have a conversation or dialogue with its customers (e.g., loyal fans, consumers, etc.). In an instance, generation (e.g., using profile component 910) of an assignment profile can increase an organizations revenue through advertising and instigating consumption. Furthermore, in an aspect, mechanisms for generating (e.g., using profile component 910) a profile assignment through a system platform as described herein are scalable (e.g., several thousands of users) and can facilitate the sourcing of rich content by brands for its advertising campaign. In an aspect, profile component 910 can generate assignments configured for a range of users such as event promoters, venue owners, agencies representing clients, publishers seeking talented artists and content, and/or brands such as consumer-focused brands. As such, a diversity of brands, users, and media content items 104 can be sourced in connection with generated profile assignments.

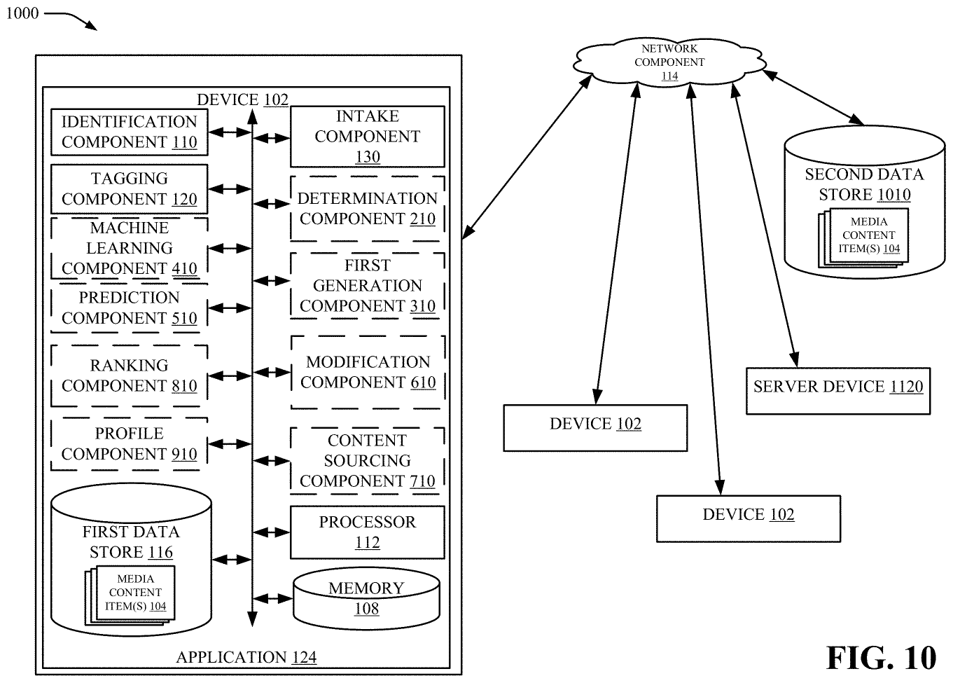

Turning now to FIG. 10, illustrated is a block diagram of an example, non-limiting system 1000 that can retrieve permissions associated with usage of media content items sourced within the media content item sourcing framework over a cloud computing network in accordance with one or more embodiments described herein. Repetitive description of like elements employed in other embodiments described herein is omitted for sake of brevity.

In an aspect, system 1000 can include one or more components of system 100A-G, 200, 300, 400, 500, 600, 700, 800, and/or 900 and can operate on one or more device including device 102 (e.g., a smart phone). In an aspect, system 1000 can comprise or otherwise access (via a network) first data store 116 that stores media content item(s) 104. In an aspect, system 1000 can comprise processor 112 and memory 108. In an aspect, processor 112 can execute the computer executable components and/or computer instructions stored in memory 108. The components of system 1000 can include identification component 110, tagging component 120, and intake component 130, determination component 210, generation component 310, machine learning component 410, prediction component 510, modification component 610, content sourcing component 710, ranking component 810, and/or profile component 910. In an aspect, one or more of the components of system 1000 can be electrically and/or communicatively coupled to one or more devices of system 1000 or other embodiments to perform one or more functions described herein.

In an aspect, FIG. 10 illustrates system 1000 (or other embodiments disclosed herein) in a cloud computing environment such that several user devices such as user device 102 (e.g., or several user devices 102) can transmit or access media content 104 and/or system 1000 components and functionality through an on-demand network access system comprising a shared pool of configurable computing resources (e.g., network 114). In an aspect, the shared computing resources can include a network of devices, a network bandwidth, server devices, virtual machines, services, memory devices, storage devices, and other resources that can be provided to several uses and utilized by such user devices 102 with minimal management effort from the administrator. Furthermore, the cloud computing environment can enable user devices 102 to utilize computing capabilities provided by network 114 in an on-demand manner such that each device can access server devices and network storage elements (e.g., second data store 1010) on an as-needed basis without intervention by a service provider in some instances.

Furthermore, the network or cloud computing environment can also allow for access to a broad network of mechanisms that enable the participation of several client platforms such as smart phones, laptops, personal digital assistants, set top boxes, tablets, computers and other such devices. In another aspect, network resources can be pooled together to service several user devices simultaneously such that each user device can consume different physical and virtual resources of the network. Furthermore, the network can be capable of dynamically assigning or reassigning resources to devices 102 based on a respective device need. In yet another aspect, the network can facilitate a fast elasticity quality that allows for the network components to quickly deploy resources and scale-up resources for deployment in instances where there is a high demand for network usage. In another aspect, the network can control and optimize the deployment of resources by using metering capabilities associated with storage, processing, bandwidth usage, and servicing of user accounts. The quanta of resources used at a given time can be monitored, managed, and reported to provide transparency to users and network administrators.

In yet another aspect, the systems disclosed herein can be deployed over a cloud-based service model including the use of the following models: Software as a Service (SaaS), Infrastructure as a Service (IaaS), and/or Platform as a Service (PaaS). In another aspect, the network can be deployed in any of several deployment model frameworks including a public cloud, private cloud, community cloud, hybrid cloud, and other such deployment models. In an aspect, the cloud computing network can include a series of interconnected nodes that allow for advancements in low coupling capabilities, modularity, semantic interoperability, and statelessness. Various embodiments of the present invention can utilize the cloud computing environment described herein to facilitate the sourcing (e.g., using content sourcing component 710), identification (e.g., using identification component 110) of data such as facial data or brand data within a media content item 104, the assignment (e.g., using tagging component 120) of tag data to facial data within a media content item 104 and/or the receipt (e.g., using intake component 130) of permission data coupled to authentication data corresponding to facial data within a media content item 104.

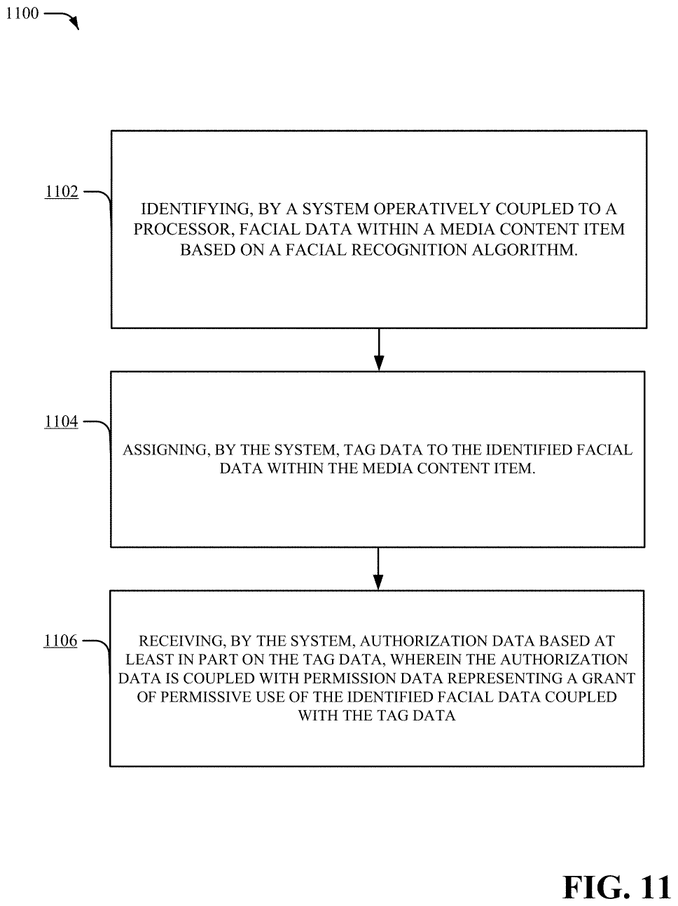

FIG. 11 illustrates a flow diagram of an example, non-limiting computer-implemented method 1100 that can facilitate a retrieval of permissions associated with usage of media content items in accordance with one or more embodiments described herein. In an aspect, one or more of the components described in computer-implemented method 1100 can be electrically and/or and in a wide range of mediums communicatively coupled to one or more devices. Repetitive description of like elements employed in other embodiments described herein is omitted for sake of brevity.

In some implementations, at reference numeral 1102, a system operatively coupled to a processor (e.g., processor 112) can identify (e.g., using identification component 110) facial data within a media content item (e.g., media content item(s) 104) based on a facial recognition algorithm. At reference numeral 1104, the system can assign (e.g., using tagging component 120) tag data to the identified facial data within the media content item. At reference numeral 1106, the system can receive (e.g., using intake component 130) authentication data based at least in part on the tag data, wherein the authentication data is coupled with permission data representing a grant of permissive use of the identified facial data coupled with the tag data.

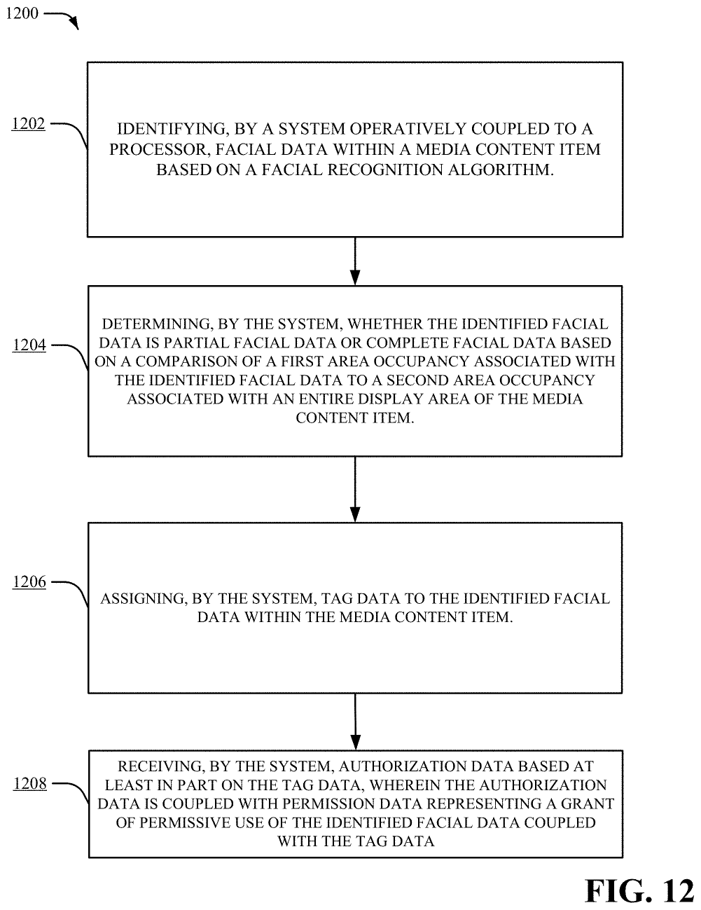

FIG. 12 illustrates a flow diagram of an example, non-limiting computer-implemented method 1200 that can facilitate a retrieval of permissions associated with usage of media content items in accordance with one or more embodiments described herein. In an aspect, one or more of the components described in computer-implemented method 1200 can be electrically and/or communicatively coupled to one or more devices. Repetitive description of like elements employed in other embodiments described herein is omitted for sake of brevity.

In some implementations, at reference numeral 1202, a system operatively coupled to a processor (e.g., processor 112) can identify (e.g., using identification component 110) facial data within a media content item (e.g., media content item(s) 104) based on a facial recognition algorithm. At reference numeral 1204, the system can determine (e.g., using determination component 210) whether the identified facial data is partial facial data or complete facial data based on a comparison of a first area occupancy associated with the identified facial data to a second area occupancy associated with an entire display area of the media content item. At reference numeral 1206, the system can assign (e.g., using tagging component 120) tag data to the identified facial data within the media content item. At reference numeral 1208, the system can receive authentication data based at least in part on the tag data, wherein the authentication data is coupled with permission data representing a grant of permissive use of the identified facial data coupled with the tag data.

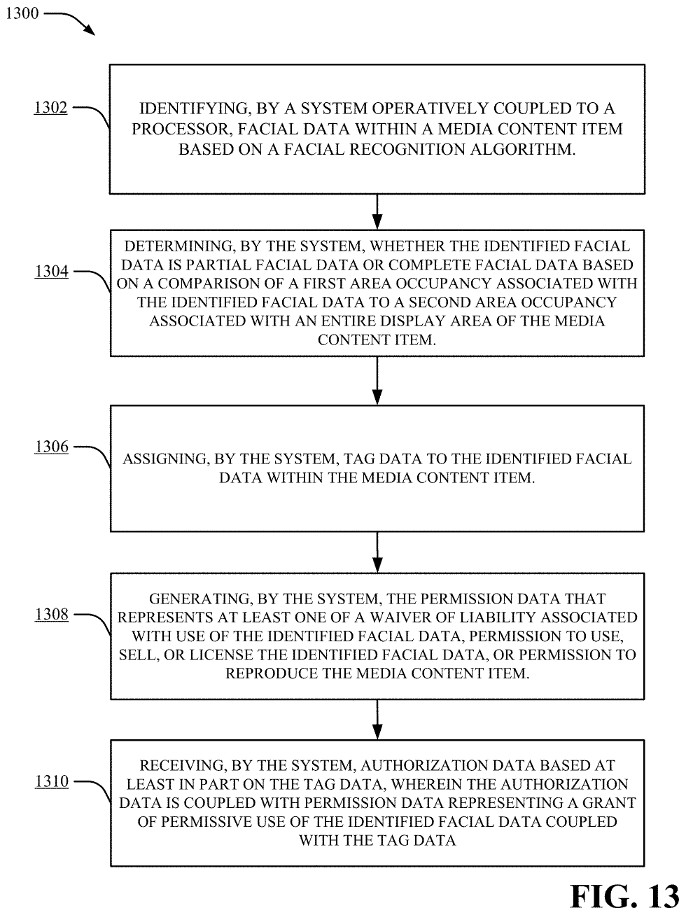

FIG. 13 illustrates a flow diagram of an example, non-limiting computer-implemented method 1300 that can facilitate a retrieval of permissions associated with usage of media content items in accordance with one or more embodiments described herein. In an aspect, one or more of the components described in computer-implemented method 1300 can be electrically and/or communicatively coupled to one or more devices. Repetitive description of like elements employed in other embodiments described herein is omitted for sake of brevity.

In some implementations, at reference numeral 1302, a system operatively coupled to a processor (e.g., processor 112) can identify (e.g., using identification component 110) facial data within a media content item (e.g., media content item(s) 104) based on a facial recognition algorithm. At reference numeral 1304, the system can determine (e.g., using determination component 210) whether the identified facial data is partial facial data or complete facial data based on a comparison of a first area occupancy associated with the identified facial data to a second area occupancy associated with an entire display area of the media content item. At reference numeral 1306, the system can assign (e.g., using tagging component 120) tag data to the identified facial data within the media content item. At reference numeral 1308, the system can generate (e.g., using generation component 310) permission data that represents at least one of a waiver of liability associated with use of the identified facial data, permission to use, sell, or license the identified facial data, or permission to reproduce the media content item. At reference numeral 1310, the system can receive (e.g., using intake component 130) authentication data based at least in part on the tag data, wherein the authentication data is coupled with permission data representing a grant of permissive use of the identified facial data coupled with the tag data.

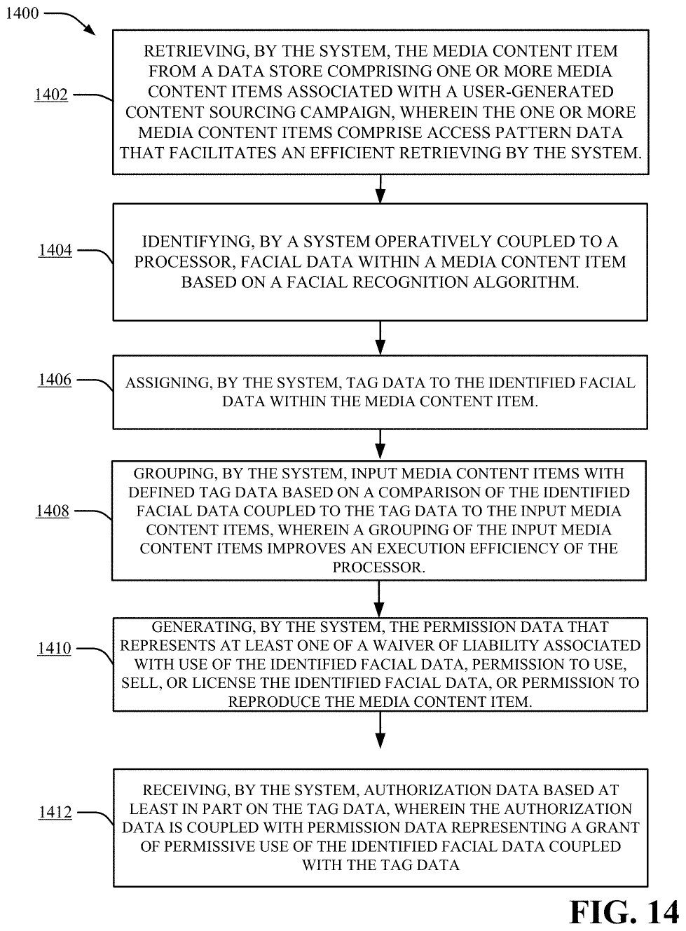

FIG. 14 illustrates a flow diagram of an example, non-limiting computer-implemented method 1400 that can facilitate a retrieval of permissions associated with usage of media content items in accordance with one or more embodiments described herein. In an aspect, one or more of the components described in computer-implemented method 1400 can be electrically and/or communicatively coupled to one or more devices. Repetitive description of like elements employed in other embodiments described herein is omitted for sake of brevity.

In some implementations, at reference numeral 1402, a system operatively coupled to a processor (e.g., processor 112) can retrieve (e.g., using content sourcing component 710) the media content item from a data store comprising one or more media content items associated with a user-generated content sourcing campaign, wherein the one or more media content items comprise access pattern data that facilitates an efficient retrieving by the system. At 1404, the system can identify (e.g., using identification component 110) facial data within a media content item (e.g., media content item(s) 104) based on a facial recognition algorithm. At reference numeral 1404, the system can determine (e.g., using determination component 210) whether the identified facial data is partial facial data or complete facial data based on a comparison of a first area occupancy associated with the identified facial data to a second area occupancy associated with an entire display area of the media content item. At reference numeral 1406, the system can assign (e.g., using tagging component 120) tag data to the identified facial data within the media content item. At reference numeral 1408, the system can group (e.g., using machine learning component 410) input media content items with defined tag data based on a comparison of the identified facial data coupled to the tag data to the input media content items, wherein a grouping of the input media content items improves an execution efficiency of the processor. At reference numeral 1410, the system can generate (e.g., using generation component 310) permission data that represents at least one of a waiver of liability associated with use of the identified facial data, permission to use, sell, or license the identified facial data, or permission to reproduce the media content item. At reference numeral 1412, the system can receive (e.g., using intake component 130) authentication data based at least in part on the tag data, wherein the authentication data is coupled with permission data representing a grant of permissive use of the identified facial data coupled with the tag data.

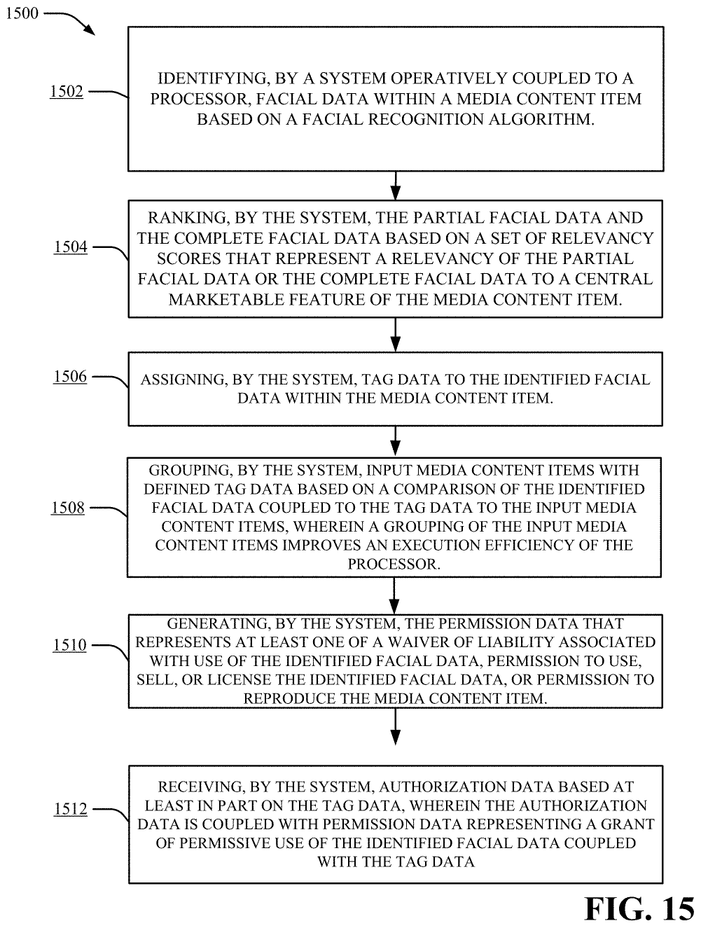

FIG. 15 illustrates a flow diagram of an example, non-limiting computer-implemented method 1500 that can facilitate a retrieval of permissions associated with usage of media content items in accordance with one or more embodiments described herein. In an aspect, one or more of the components described in computer-implemented method 1500 can be electrically and/or communicatively coupled to one or more devices. Repetitive description of like elements employed in other embodiments described herein is omitted for sake of brevity.

In some implementations, at reference numeral 1502, a system operatively coupled to a processor (e.g., processor 112) can identify (e.g., using identification component 110) facial data within a media content item (e.g., media content item(s) 104) based on a facial recognition algorithm. At reference numeral 1504, the system can rank (e.g., using ranking component 810) the partial facial data and the complete facial data based on a set of relevancy scores that represent a relevancy of the partial facial data or the complete facial data to a central marketable feature of the media content item. At reference numeral 1506, the system can assign (e.g., using tagging component 120) tag data to the identified facial data within the media content item. At reference numeral 1508, the system can group (e.g., using machine learning component 410) input media content items with defined tag data based on a comparison of the identified facial data coupled to the tag data to the input media content items, wherein a grouping of the input media content items improves an execution efficiency of the processor. At reference numeral 1510, the system can generate (e.g., using generation component 310) permission data that represents at least one of a waiver of liability associated with use of the identified facial data, permission to use, sell, or license the identified facial data, or permission to reproduce the media content item. At reference numeral 1512, the system can receive (e.g., using intake component 130) authentication data based at least in part on the tag data, wherein the authentication data is coupled with permission data representing a grant of permissive use of the identified facial data coupled with the tag data.

The computer processing systems, computer-implemented methods, apparatus and/or computer program products employ hardware and/or software to solve problems that are highly technical in nature (e.g., related to autonomous identification, tagging, machine-learning based grouping, media content segmenting, custom generating permission data and authentication data, modifying several data points into unique data points, etc.), that are not abstract and cannot be performed as a set of mental acts by a human. Humans are inherently limited in mental processing capabilities and one or more embodiments of the present invention can facilitate ranking, ordering, organizing, comparing, grouping and performing several other tasks simultaneously. Furthermore, several of the inventive aspects disclosed herein can be deployed using cloud computing resources and/or neural networks which increases the processing power, storage efficiencies and other capabilities that cannot be achieved by a human.

In another aspect, the hardware and/or software elements described herein sole other problems that are highly technical in nature (e.g., semantic tagging, matching disparate data such as facial data, tag data, and identification data composed of millions of data points in some instances) that cannot be performed as a set of mental acts by a human due to the processing capabilities need to facilitate data mapping and data modification, for example. Further, some of the processes performed may be performed by a specialized computer for carrying out defined tasks related to memory operations. For example, a specialized computer can be employed to carry out tasks related to content segmenting, content identification, machine learning processes or the like. The systems 100A-G, 200, 300, 400, 500, 600, 700, 800, 900 and/or 1000 and/or components of the systems can be employed to solve new problems that arise through advancements in technology, computer networks, the Internet and the like. For example, the new problems solved can be or include obtaining permissions and/or authorizations related to media content items 104 and conducting distribution and/or selection of information related to media content items for particular entities based on a relationship between requirements of a marketing campaign profile (e.g., rules, requirements, required data sets) and data subsets presented in a media content item submitted by several user devices.

In yet another aspect, aspects disclosed herein can be integrated with the tangible and physical infrastructure components of one or more cloud computing environments. In another aspect the systems and methods disclosed can be integrated with physical devices such as smart phone devices, tablets, desktop computers, mobile devices, and other such hardware. Furthermore, the ability to employ iterative machine learning techniques to categorize, group, and identify similarities several (e.g., millions) media content items simultaneously cannot be performed by a human. For example, a human is unable to group image segments or video segments from several user devices simultaneously and compare similarities based on machine learning and artificial intelligence comparative techniques in an efficient and accurate manner to meet criteria defined by brand marketing campaign assignments. Furthermore, a human is unable to simultaneously access and employ permission data and authorization data associated with grouped and similar data from media content items based on artificial intelligence techniques and/or the packaging of data into data packets for communication between a main processor (e.g., using processor 112) and a memory (e.g., memory 108) to simultaneously facilitate the grouping of data associated with thousands of media content items simultaneously.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because a grouping of data is performed utilizing iterative machine learning and artificial intelligence techniques that facilitate a recurrent and precise grouping of media content item 104 data into groups based on similarity comparisons (e.g., similarities of tag data, identification data, facial data, product data, brand data, etc.) is performed by components executed by a processor (e.g., processor 112) established from a combination of electrical and mechanical components and circuitry, a human is unable to replicate or perform the subject data packet configuration and/or the subject communication between processing components, a machine learning component and/or a identification component, tagging component, intake component, and/or determination component. Furthermore, the similarity comparisons between grouped and ungrouped data sets are based on comparative determinations that only a computer can perform such as iterative grouping, evaluation, and review of media content item 104 data based on unique signatures within the data and use of computer-implemented operations to recognize digital patterns within computer generated data representations to iteratively group data into respective groups. The generation of digital data based on pattern recognition algorithms and data similarity algorithms as well as storage and retrieval of digitally generated data to and from a memory (e.g., using memory 108) in accordance with computer generated access patterns cannot be replicated by a human.

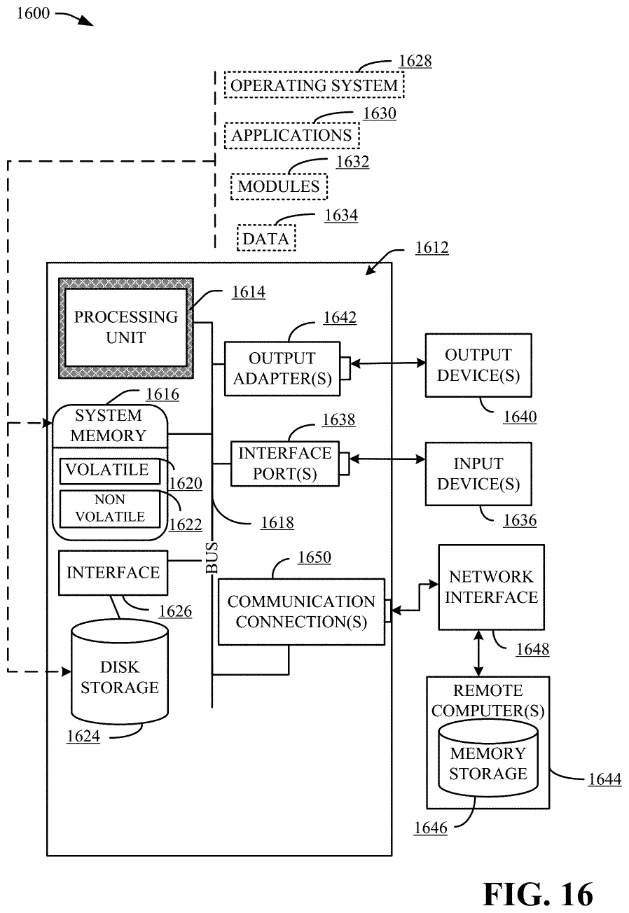

In order to provide a context for the various aspects of the disclosed subject matter, FIG. 16 as well as the following discussion is intended to provide a general description of a suitable environment in which the various aspects of the disclosed subject matter can be implemented. FIG. 16 illustrates a block diagram of an example, non-limiting operating environment in which one or more embodiments described herein can be facilitated. With reference to FIG. 16, a suitable operating environment 1600 for implementing various aspects of this disclosure can also include a computer 1612. The computer 1612 can also include a processing unit 1614, a system memory 1616, and a system bus 1618. The system bus 1618 couples system components including, but not limited to, the system memory 1616 to the processing unit 1614. The processing unit 1614 can be any of various available processors. Dual microprocessors and other multiprocessor architectures also can be employed as the processing unit 1614. The system bus 1618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1616 can also include volatile memory 1620 and nonvolatile memory 1622. The basic input/output system (BIOS), containing the basic routines to transfer information between elements within the computer 1612, such as during start-up, is stored in nonvolatile memory 1622. By way of illustration, and not limitation, nonvolatile memory 1622 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1620 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1612 can also include removable/non-removable, volatile/non-volatile computer storage media. FIG. 16 illustrates, for example, a disk storage 1624. Disk storage 1624 can also include, but is not limited to, devices like a magnetic disk drive, floppy disk drive, tape drive, Jaz drive, Zip drive, LS-100 drive, flash memory card, or memory stick. The disk storage 1624 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1624 to the system bus 1618, a removable or non-removable interface is typically used, such as interface 1626. FIG. 16 also depicts software that acts as an intermediary between users and the basic computer resources described in the suitable operating environment 1600. Such software can also include, for example, an operating system 1628. Operating system 1628, which can be stored on disk storage 1624, acts to control and allocate resources of the computer 1612.

System applications 1630 take advantage of the management of resources by operating system 1628 through program modules 1632 and program data 1634, e.g., stored either in system memory 1616 or on disk storage 1624. It is to be appreciated that this disclosure can be implemented with various operating systems or combinations of operating systems. A user enters commands or information into the computer 1612 through input device(s) 1636. Input devices 1636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1614 through the system bus 1618 via interface port(s) 1638. Interface port(s) 1638 include, for example, a serial port, a parallel port, a game port, and a universal serial bus (USB). Output device(s) 1640 use some of the same type of ports as input device(s) 1636. Thus, for example, a USB port can be used to provide input to computer 1612, and to output information from computer 1612 to an output device 1640. Output adapter 1242 is provided to illustrate that there are some output device 1640 like monitors, speakers, and printers, among other such output device 1640, which require special adapters. The output adapters 1642 include, by way of illustration and not limitation, video and sound cards that provide a means of connection between the output device 1640 and the system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. The remote computer(s) 1644 can be a computer, a server, a router, a network PC, a workstation, a microprocessor based appliance, a peer device or other common network node and the like, and typically can also include many or all of the elements described relative to computer 1612. For purposes of brevity, only a memory storage device 1646 is illustrated with remote computer(s) 1644. Remote computer(s) 1644 is logically connected to computer 1612 through a network interface 1648 and then physically connected via communication connection 1650. Network interface 1648 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1650 refers to the hardware/software employed to connect the network interface 1648 to the system bus 1618. While communication connection 1650 is shown for illustrative clarity inside computer 1612, it can also be external to computer 1612. The hardware/software for connection to the network interface 1648 can also include, for exemplary purposes only, internal and external technologies such as, modems including regular telephone grade modems, cable modems and DSL modems, ISDN adapters, and Ethernet cards.

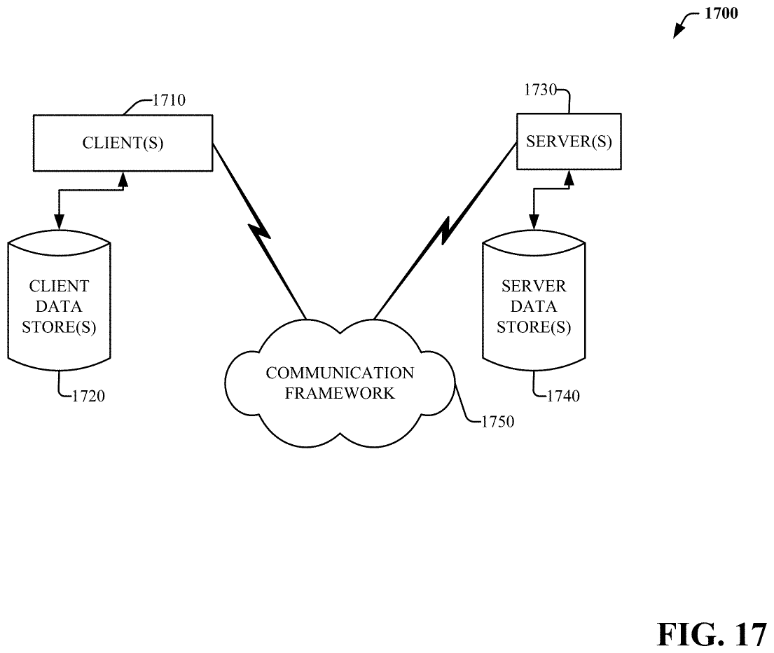

Referring now to FIG. 17, there is illustrated a schematic block diagram of a computing environment 1700 in accordance with this disclosure. The system 1700 includes one or more client(s) 1702 (e.g., laptops, smart phones, PDAs, media players, computers, portable electronic devices, tablets, and the like). The client(s) 1702 can be hardware and/or software (e.g., threads, processes, computing devices). The system 1700 also includes one or more server(s) 1704. The server(s) 1704 can also be hardware or hardware in combination with software (e.g., threads, processes, computing devices). The servers 1704 can house threads to perform transformations by employing aspects of this disclosure, for example. One possible communication between a client 1702 and a server 1704 can be in the form of a data packet transmitted between two or more computer processes wherein the data packet may include video data. The data packet can include a metadata, e.g., associated contextual information, for example. The system 1700 includes a communication framework 1706 (e.g., a global communication network such as the Internet, or mobile network(s)) that can be employed to facilitate communications between the client(s) 1702 and the server(s) 1704.

Communications can be facilitated via a wired (including optical fiber) and/or wireless technology. The client(s) 1702 include or are operatively connected to one or more client data store(s) 1708 that can be employed to store information local to the client(s) 1702 (e.g., associated contextual information). Similarly, the server(s) 1704 are operatively include or are operatively connected to one or more server data store(s) 1710 that can be employed to store information local to the servers 1704. In one embodiment, a client 1702 can transfer an encoded file, in accordance with the disclosed subject matter, to server 1704. Server 1704 can store the file, decode the file, or transmit the file to another client 1702. It is to be appreciated, that a client 1702 can also transfer uncompressed file to a server 1704 and server 1704 can compress the file in accordance with the disclosed subject matter. Likewise, server 1704 can encode video information and transmit the information via communication framework 1706 to one or more clients 1702.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a system operatively coupled to a processor, facial data within a media content item based on a facial recognition algorithm;
assigning, by the system, name data to each face based on input data, historical data, comparative facial data models, or machine learning data models to determine a name identifier associated with the facial data; and
receiving, by the system, signature data that corresponds with first document data representing a permissive use of the assigned data and the facial data for a defined purpose.
